(19) United States
(12) Patent Application Publication
(10) Pub. No.: US 2026/0363930 A1
(43) Pub. Date: Nov. 19, 2026

(54) Device for Positioning a Patient on a Patient Support Apparatus and Method Therefor

(71) Applicant: Linet spol. s.r.o., Slany (CZ)

(72) Inventors: Michal Salus, Roudnice and Labem (CZ); Bronislav Siuda, Trinec (CZ); Petr Mil, Baska (CZ)

(73) Assignee: Linet spol. s.r.o., Slany (CZ)

(21) Appl. No.: 19/676,915

(22) Filed: May 14, 2026

Related U.S. Application Data
(60) Provisional application No. 63/805,496, filed on May 14, 2025.

(51) Int. Cl. A61G 7/10; A61G 7/015; A61G 7/07

(52) U.S. Cl. CPC A61G 7/1026; A61G 7/015; A61G 7/07; A61G 7/1065

(57) ABSTRACT

A patient positioning device may be integrated into a patient support apparatus, such as a hospital bed, and operable to move a sheet supporting a patient toward a head end of the patient support apparatus. In certain embodiments, the device may comprise a bracket supported relative to a movable backrest section of a bed deck supporting a mattress. Movement of the sheet may be effected by movement of a drive component of the patient support apparatus, including movement of the backrest section or movement of an upper frame relative to a base frame or chassis. In other embodiments, movement of the sheet may be effected by an independent drive mechanism.

### CROSS-REFERENCE TO RELATED APPLICATIONS

This application claims the benefit of United States Provisional Application No. 63/805,496, filed May 14, 2025, the disclosure of which is incorporated herein by reference in its entirety.

### BACKGROUND

The present invention relates generally to patient boosting or positioning devices and, more particularly, to devices and systems for boosting or repositioning patients relative to patient support apparatus in hospitals, nursing facilities, home-care environments and other care settings.

Patients who are confined to beds in hospitals, nursing facilities and home-care environments often move from their intended position in a bed due to gravitational forces, bed articulation, patient movement and interactions between the patient and the support surface. One of the primary causes is elevation of the backrest section of the bed. When the backrest section is raised to support sitting, eating, breathing or clinical treatment, gravity causes the patient’s body to gradually slide downward toward the foot end of the bed. This migration commonly occurs even when the movement is slow or not immediately noticeable.

The materials and geometry of the mattress and bedding (e.g., sheet) may also contribute to patient movement. Compression of the mattress beneath the patient, combined with low-friction bedding surfaces or shifting support contours during bed articulation, can allow the patient to progressively migrate downward over time. Repeated adjustments of the bed, such as raising or lowering the backrest or leg sections, may further contribute to positioning drift.

Patient-generated movement may also contribute to positional migration. Patients may unconsciously shift during sleep, adjust posture for comfort, move during coughing or breathing or reposition themselves in response to pain, discomfort, muscle weakness, spasms or neurological conditions. Even limited movement can gradually alter the patient’s position on the bed.

Clinical procedures and caregiver interactions may also unintentionally change patient positioning. Activities such as turning, bathing, wound care, therapy, transfers or adjusting medical equipment can result in gradual displacement of the patient relative to the bed surface.

Additionally, certain patient populations are especially susceptible to positional migration, including sedated patients, bariatric patients, elderly patients, patients with reduced muscle tone and patients with impaired mobility or neurological deficits. These patients may be unable to counteract gravitational sliding or restore their own alignment once movement occurs, thereby necessitating periodic repositioning by caregivers.

Patients in hospitals, nursing facilities and home-care environments are currently repositioned using a combination of manual caregiver effort, friction-reducing aids, powered bed articulation and specialized transfer equipment. The specific method depends on the patient’s mobility level, weight, clinical condition and the purpose of the repositioning maneuver.

For routine in-bed repositioning, caregivers commonly use draw sheets positioned beneath the patient, friction-reducing slide sheets configured to reduce friction between the patient and the mattress surface, transfer mats configured to facilitate patient transfer operations, or other repositioning sheets placed beneath the patient.

Modern hospital beds may also assist repositioning through powered articulation features. For example, caregivers may place the bed in a Trendelenburg position (i.e., a position in which the patient’s head is lower than the patient’s feet) to reduce the effective force required to move the patient upward. Caregivers may additionally lower the backrest section before repositioning to reduce friction and shear forces acting on the patient’s skin. However, even with these adjustments, manual pulling is still commonly required.

Some facilities utilize powered patient repositioning systems retrofitted to beds. These systems may employ motorized sheet pullers, conveyor-like mechanisms, inflatable air-assisted devices or powered rollers configured to reposition the patient relative to the mattress surface. Certain systems may attempt to adjust tension in a repositioning sheet or utilize limited coordination with bed articulation to assist movement of the patient. These systems are less common because they can be expensive, mechanically complex, difficult to clean or incompatible with existing bed architectures.

Powered patient repositioning systems also require specialized sheets, accessories or disposable components that may not always be readily available during routine patient care. In certain clinical environments, the required repositioning sheets may be removed during laundering, replaced with incompatible linens or otherwise unavailable when repositioning is needed. Existing repositioning systems may additionally require additional setup time, caregiver training, cleaning procedures, storage accommodations or compatibility modifications with existing patient support apparatus. In some cases, caregivers may continue to rely upon manual repositioning techniques because such techniques are perceived as faster, more familiar or more readily available during routine clinical operations. Certain standalone repositioning systems may also lack integration with existing bed articulation functions, therapeutic positioning systems or caregiver workflows, thereby limiting widespread adoption in hospitals, nursing facilities and home-care environments.

Existing repositioning approaches may additionally require separate caregiver actions or independent equipment operation that are not coordinated with movement or control functions of the patient support apparatus.

Ceiling lift and mobile floor lift systems may also be used for repositioning or partial lifting of patients. These systems reduce caregiver strain by transferring a portion or all of the patient’s weight to a sling-supported lifting apparatus. However, such lifts generally require additional setup time, space, caregiver training and patient cooperation, and may not be practical for frequent repositioning operations.

Clinical repositioning is performed for several reasons, including improving patient comfort, restoring proper posture after migration toward the foot end of the bed, reducing pressure injury risk, facilitating respiratory function, assisting wound care and enabling safer caregiving procedures. Frequent repositioning is particularly important for immobile patients and is often mandated by institutional protocols to reduce pressure ulcer formation and other complications associated with prolonged static positioning.

Patients may require repositioning for a variety of medical, ergonomic and safety-related reasons. Patient migration can result in poor posture, discomfort, increased shear forces on the skin and undesirable positioning relative to the bed and support surfaces. Repositioning may additionally be necessary to maintain spinal or skeletal alignment, facilitate breathing and pulmonary function, assist circulation and support recovery following surgery or injury. Certain medical conditions, including paralysis, sedation, weakness, obesity, neurological disorders or critical illness, may prevent a patient from independently repositioning themselves, thereby requiring assistance from a caregiver.

Repositioning may also be performed to facilitate caregiving activities, including hygiene care, wound treatment, dressing changes, physical therapy, feeding, imaging procedures and transfers into or out of the bed. During clinical treatment, patients may need to be repeatedly adjusted to maintain proper therapeutic positioning or to accommodate changes in bed articulation, such as elevation of the backrest section.

Additionally, repositioning may be necessary to reduce pressure, shear and friction forces acting on the patient’s skin and soft tissue. Patients who remain in the same position for prolonged periods may experience restricted blood flow to tissue compressed between bony prominences and the mattress surface, thereby increasing the risk of pressure injuries, including pressure ulcers or bedsores. As patients gradually slide downward on the mattress surface, the skin may remain relatively stationary while underlying tissue shifts, thereby increasing the risk of tissue damage and discomfort. Proper repositioning helps restore alignment, redistribute pressure and reduce these potentially harmful forces.

A device is needed that can reposition a patient toward the head end of a patient support apparatus while minimizing caregiver effort, without significantly increasing system cost, and while permitting efficient cleaning and sanitization.

### SUMMARY OF THE INVENTION

The present invention is directed to a patient boosting or positioning device that may be integrated into a patient support apparatus, such as a bed for use in hospitals, nursing facilities, home-care environments and other care settings, for boosting or repositioning patients relative to patient support apparatus. The device is operable to boost or move a boosting sheet supporting a patient toward a head end of the patient support apparatus. In certain embodiments, the device may comprise a boosting bracket having a first end pivotally supported relative to a movable backrest section of a bed deck configured to support a mattress.

Pivotal movement of the bracket may be effected by movement of a drive component of the patient support apparatus. In one embodiment, the drive component may comprise a drive component associated with the movable backrest section. In another embodiment, the drive component may comprise a lifting mechanism of the patient support apparatus, such as a column mechanism, scissors mechanism or other suitable lifting arrangement configured to effect movement of an upper frame of the patient support apparatus. The upper frame may support the backrest section and may itself be supported for movement relative to a base frame or chassis configured to be supported on a supporting surface.

In certain embodiments, the patient positioning device may further comprise a connecting element operatively connecting the bracket to the upper frame or, alternatively, to the base frame. The connecting element may comprise a cable, wire, chain, rope, belt or other suitable structure and may hereinafter be referred to as a cable for ease of reference. In such embodiments, movement of the backrest section or another movable portion of the patient support apparatus may tension the cable to effect movement of the bracket, thereby pulling the sheet and the patient supported thereon.

The patient positioning device may further comprise a winder configured to gather or remove slack from the cable when the backrest section is moved in a second direction opposite the first direction. As used herein, the term “winder” is intended to broadly include devices configured to wind, retract, tension, gather, store or otherwise control movement of a flexible element, including but not limited to rotating drums, reels, spools, retractors, winches, take-up mechanisms and spring-biased tensioning devices.

The patient positioning device may further comprise an optional guide element positioned proximate an upper corner of a mattress adjacent a head end of the patient support apparatus. In one embodiment, the guide element may comprise a pulley configured to guide movement of the sheet relative to the mattress. As used herein, the term “guide element” is intended to broadly include structures configured to direct, support, guide, redirect or reduce friction associated with movement of a sheet, cable, belt, strap or other flexible element. Exemplary guide elements may include pulleys, rollers, rotatable cylinders, guide rails, channels, grooves, low-friction sliding members, tubular guides, rods, eyelets, fairleads, bushings or other suitable guiding structures. If friction between the mattress and the sheet permits relative movement therebetween, the guide element may be omitted.

In certain embodiments, operation of the patient positioning device may be coordinated with one or more additional functions of the patient support apparatus, including articulation of the backrest section, movement of the upper frame, movement into or out of a Trendelenburg position, activation of migration-reduction functions, ergonomic support features or other therapeutic positioning functions.

Various advantages of the invention will become apparent to those skilled in the art from the following detailed description of preferred embodiments and the accompanying drawings.

### BRIEF DESCRIPTION OF THE DRAWINGS

Various features and attendant advantages of the patient boosting or positioning device will become more fully appreciated when considered in view of the accompanying drawings, in which like reference characters designate the same or similar parts and/or features throughout the several views, and wherein:

FIG. 1 is a simplified diagrammatic representation, in side elevation, of an exemplary patient boosting or positioning device supported in relation to an exemplary patient support apparatus, shown in relevant part, with the patient positioning device operated in a first position,

FIG. 2 is a simplified diagrammatic representation, in side elevation, of the patient positioning device and the patient support apparatus shown in FIG. 1, with the patient positioning device operated in a second position,

FIG. 3 is a composite (i.e., multiple positions/states shown together) diagrammatic representation, in side elevation, of the patient positioning device and the patient support apparatus shown in FIG. 1, with the patient positioning device operated in the first and second positions,

FIG. 4 is a simplified diagrammatic representation, in side elevation, of the patient positioning device supported in relation to the patient support apparatus in an alternative configuration, with the patient positioning device operated in the first position,

FIG. 5 is a simplified diagrammatic representation, in side elevation, of the patient positioning device and the patient support apparatus shown in FIG. 4, with the patient positioning device operated in a second position,

FIG. 6 is a composite diagrammatic representation, in side elevation, of the patient positioning device and the patient support apparatus shown in FIG. 4, with the patient positioning device operated in the first and second positions,

FIG. 7 is a diagrammatic representation, in side elevation, of an alternative patient positioning device supported in relation to an exemplary patient support apparatus, shown in relevant part, with the patient positioning device operated in a first position,

FIG. 8 is a simplified diagrammatic representation, in side elevation, of the patient positioning device and the patient support apparatus shown in FIG. 7, with the patient positioning device operated in a second position,

FIG. 9 is a composite diagrammatic representation, in side elevation, of the patient positioning device and the patient support apparatus shown in FIG. 7, with the patient positioning device operated in the first and second positions,

FIG. 10 is a composite diagrammatic representation, in side elevation, of a tensioning device operatively connected to an exemplary patient positioning device supported in relation to an exemplary patient support apparatus, with a drive mechanism removed to simplify the view,

FIG. 11 is a simplified diagrammatic representation, in side elevation, of another patient positioning device supported in relation to an exemplary patient support apparatus, shown in relevant part, with the patient positioning device operated in a first position,

FIG. 12 is a simplified diagrammatic representation, in side elevation, of the patient positioning device and the patient support apparatus shown in FIG. 11, with the patient positioning device operated in a second position,

FIG. 13 is a simplified diagrammatic representation, in side elevation, of the patient positioning device shown in FIG. 11 supported in relation to the patient support apparatus in an alternative configuration, with the patient positioning device operated in the first position,

FIG. 14 is a simplified diagrammatic representation, in side elevation, of the patient positioning device and the patient support apparatus shown in FIG. 13, with the patient positioning device operated in a second position,

FIG. 15 is a diagrammatic representation, in side elevation, of another patient positioning device and the patient support apparatus, similar to that shown in FIG. 1, with the patient positioning device operated in a first position,

FIG. 16 is a diagrammatic representation, in side elevation, of the patient positioning device and the patient support apparatus shown in FIG. 15, with the patient positioning device operated in a second position,

FIG. 17 is a diagrammatic representation, in side elevation, of the patient positioning device and the patient support apparatus shown in FIG. 15, with the patient positioning device operated in a third position,

FIG. 18 is a diagrammatic representation, in side elevation, of an alternative patient positioning device supported in relation to an exemplary patient support apparatus, shown in relevant part, with the patient positioning device operated in a first position,

FIG. 19 is a diagrammatic representation, in side elevation, of the alternative patient positioning device shown in FIG. 18, with the patient positioning device operated in a second position to pull or move the sheet,

FIG. 20 is a diagrammatic representation, in side elevation, of the alternative patient positioning device shown in FIG. 18, with the patient positioning device returned to the first position to produce a sheet bubble,

FIG. 21 is a diagrammatic representation, in side elevation, of yet another patient positioning device and the patient support apparatus, similar to that shown in FIGS. 15-17, with the patient positioning device operated in a first position,

FIG. 22 is a diagrammatic representation, in side elevation, of the patient positioning device and the patient support apparatus shown in FIG. 21, with the patient positioning device operated in a second position in which the sheet is tensioned to reposition a patient,

FIG. 23 is a diagrammatic representation, in side elevation, of the patient positioning device and the patient support apparatus shown in FIG. 21, with the patient positioning device operated in a third position in which slack in the sheet is gathered by a winder,

FIG. 24 is a diagrammatic representation, in top plan, of an exemplary sheet and winder onto which the sheet may be fed,

FIGS. 25A-25C are diagrammatic cross-sectional representations of an exemplary sheet, shown in relevant part, received on an exemplary winder,

FIGS. 26A-26D are diagrammatic cross-sectional representations of an exemplary sheet, shown in relevant part, received on an alternative winder,

FIG. 27 is a diagrammatic representation, in perspective, of an exemplary patient support apparatus with an exemplary sheet retention configuration for retaining a sheet for movement relative to a mattress and bed deck,

FIG. 28 is a diagrammatic representation, in perspective, of a relevant portion of the exemplary patient support apparatus shown in FIG. 27, enlarged to illustrate details of the apparatus, including a guide rail and tensioning element supported for movement relative thereto,

FIG. 29 is a diagrammatic representation, in perspective, of an alternative tensioning element supported for movement relative to a guide rail,

FIG. 30 is a diagrammatic representation, in perspective, of an alternative sheet retention configuration in which a guide profile is integrated into a mattress cover associated with a mattress of the patient support apparatus, and

FIG. 31 is a diagrammatic representation, in perspective, of the sheet retention configuration shown in FIG. 30, illustrating a tensioning element supported for sliding movement relative to the guide profile integrated into the mattress cover.

### DETAILED DESCRIPTION OF THE PREFERRED EMBODIMENT

In light of the aforementioned figures, and in accordance with the adopted numbering, exemplary embodiments of the invention are illustrated and described in further detail below.

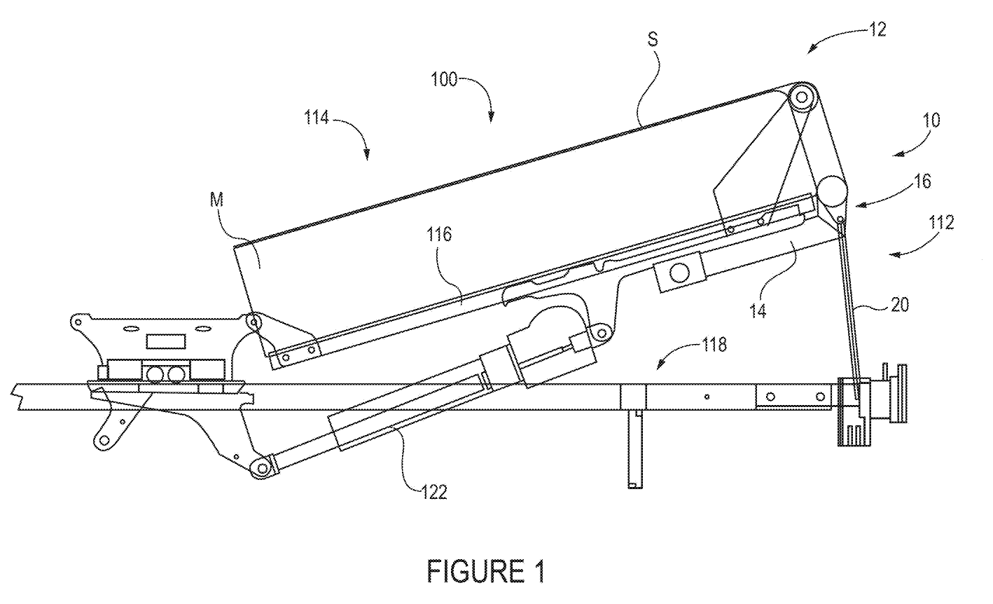

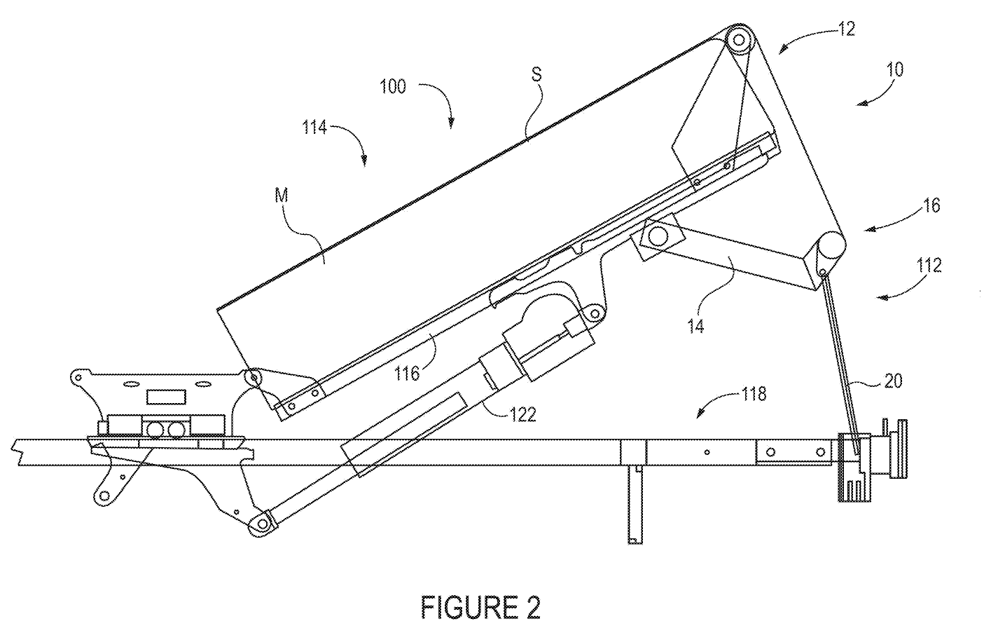

With reference to FIGS. 1-3, an exemplary patient boosting or positioning device 10 is supported in relation to an exemplary patient support apparatus 100 for boosting or repositioning patients relative to the patient support apparatus 100 in hospitals, nursing facilities, home-care environments and other care settings.

As used herein, the term “patient support apparatus” is intended to broadly include structures configured to support a patient during treatment, transport, examination, recovery, therapy or caregiving procedures. Exemplary patient support apparatus may include hospital beds, birthing beds, stretchers, transport gurneys, emergency room beds, surgical tables, operating tables, examination tables, imaging tables, procedure tables, intensive care beds, bariatric beds, rehabilitation beds, long-term care beds, nursing-home beds, home-care beds, pediatric beds and other therapeutic or patient-support platforms configured to support a patient.

The patient positioning device 10 may be fully mechanical and may operate without an additional drive component dedicated solely to the patient positioning device 10. Movement of the patient positioning device 10 may be effected by movement of a drive component of the patient support apparatus 100, such as a drive component associated with a backrest section 114 or a lifting mechanism of the patient support apparatus 100, such as one or more lifting columns 124 or scissors mechanisms for raising and lowering a bed deck of the patient support apparatus 100 relative to a chassis or base frame of the patient support apparatus 100. The drive component of the patient support apparatus 100 may be powered by an onboard battery when external power is unavailable.

As shown in FIGS. 1-3, the patient positioning device 10 is operable to pull a boosting sheet S supporting a patient. The patient positioning device 10 may comprise a pulley 12 at a head end 112 of the patient support apparatus 100, adjacent the backrest section 114 of a bed deck 116 and proximate an upper corner of a mattress M supported by the bed deck 116.

The pulley 12 may be attached, connected or otherwise supported relative to the patient support apparatus 100 in a variety of suitable manners. For example, the pulley 12 may be mounted relative to the backrest section 114 or the bed deck 116 of the patient support apparatus 100 through brackets, arms, supports, bearings, shafts, pins, axles, fasteners, weldments, rivets, screws, bolts or adhesive connections. In certain embodiments, the pulley 12 may be rotatably supported on a shaft or axle extending between opposing support brackets. In other embodiments, the pulley 12 may be integrated into a guide structure, housing, rail or molded support component associated with the patient support apparatus. The pulley 12 may additionally be fixed, pivotally mounted, adjustably mounted or removably mounted relative to the patient support apparatus 100 depending upon the intended application. The pulley 12 may be omitted if friction between the sheet S and the mattress M permits the sheet S to move relative to the mattress M. The pulley 12 may extend laterally across the mattress M, extend generally parallel to the mattress M or otherwise be supported relative to the mattress M.

It should be appreciated that other suitable guide structures may be used in place of the pulley 12. Although the guide element is illustrated as a pulley 12 in certain embodiments, other suitable guide structures may be employed in place of the pulley 12. For example, the guide structure may comprise a roller, rotatable tube, rotatable cylinder, guide rod, low-friction slide member, guide rail, channel, groove, track, fairlead, eyelet, tubular guide, bushing, curved guide surface, wear strip, low-friction polymeric guide member, bearing-supported guide member or other structure configured to direct, support or reduce friction associated with movement of the sheet S during boosting operation of the patient positioning device 10.

In certain embodiments, the guide structure may comprise or be coated with a low-friction material configured to facilitate movement of the sheet S. Exemplary low-friction materials may include nylon, polytetrafluoroethylene (PTFE), ultra-high-molecular-weight polyethylene (UHMW polyethylene), acetal, polyoxymethylene (POM), polyethylene, polypropylene, fluoropolymer materials, silicone-containing materials, low-friction elastomers, composite bearing materials or other polymeric, metallic or coated materials configured to reduce friction, wear or noise during operation of the patient positioning device 10.

A boosting bracket 14 may have a first end pivotally attached to, or otherwise supported relative to, the backrest section 114 of the bed deck 116. The bracket 14 may be pivotally attached to, or otherwise supported relative to, the backrest section 114 in a variety of suitable manners. For example, the bracket 14 may be connected relative to the backrest section 114 through one or more hinges, pivot joints, pins, shafts, axles, bearings, bushings, brackets, linkages or articulated support members. In certain embodiments, the bracket 14 may be rotatably supported on a shaft extending laterally relative to the backrest section 114. In other embodiments, the bracket 14 may be supported through one or more pivot arms, hinge plates, clevis joints, spherical joints or flexible coupling structures permitting relative movement between the bracket 14 and the backrest section 114. The bracket 14 may additionally be fixed, removably mounted, slidably supported or otherwise operatively connected relative to the backrest section 114 depending upon the intended application and operational characteristics of the patient positioning device 10.

In certain embodiments, the bracket 14 and the laterally extending structure 16 may together define a generally T-shaped structure. For example, the bracket 14 may comprise a laterally centered structural member extending from the bed deck 116 or the backrest section 114 toward the head end 112 of the patient support apparatus 100. In one embodiment, a first end of the laterally centered structural member may be pivotally attached to, or otherwise supported for pivotal movement relative to, the bed deck 116 or the backrest section 114, while an opposing second end thereof is fixed relative to the laterally extending structure 16 such that the bracket 14 and laterally extending structure 16 pivot together as a unit. In another embodiment, the laterally centered structural member may be fixed relative to the bed deck 116 or the backrest section 114, and the laterally extending structure 16 may be pivotally attached to, or otherwise supported for pivotal movement relative to, the laterally centered structural member. The laterally extending structure 16 may extend generally perpendicular to the laterally centered structural member and may extend laterally across at least a portion of the width of the mattress M or bed deck 116. The sheet S may be attached to, wrapped around, looped over, hooked to, retained by or otherwise supported relative to the laterally extending structure 16 so that movement of the bracket 14 and/or laterally extending structure 16 causes corresponding movement of the sheet S during operation of the patient positioning device 10.

Alternatively, a plurality of brackets 14 may be provided for supporting the laterally extending structure 16 in a variety of suitable structural configurations. In certain embodiments, the bracket or brackets 14 and laterally extending structure 16 may be formed as a single integral component, such as a U-shaped weldment, tubular frame, bent rod structure, cast structure, molded structure or fabricated assembly. In one embodiment, the U-shaped structure may comprise a pair of laterally spaced structural members extending from opposing lateral sides or edges of the backrest section 114 or another portion of the patient support apparatus 100. The laterally spaced structural members may be connected by the laterally extending structure 16 extending generally across at least a portion of or in relation to the width of the mattress M. First ends of the laterally spaced structural members may be pivotally attached to, or otherwise supported relative to, the backrest section 114 so that the U-shaped structure pivots as a unit during boosting operation of the patient positioning device 10. The sheet S may be attached to, wrapped around, looped over, hooked to, retained by or otherwise supported relative to the laterally extending structure 16 so that movement of the U-shaped structure pulls the sheet S and correspondingly repositions the patient supported thereon.

It should be appreciated that the bracket or brackets 14 and laterally extending structure 16 are not limited to U-shaped or T-shaped arrangements and may comprise other suitable structural configurations, including Y-shaped structures, H-shaped structures, articulated structures, telescoping structures, cantilevered support arrangements, dual-arm support arrangements or other suitable structures configured to support and move the sheet S during boosting operation of the patient positioning device 10.

The bracket or brackets 14 and/or the laterally extending structure 16 may support an end or edge of the sheet S beneath the mattress M proximate the head end 112 of the patient support apparatus 100. The backrest section 114 of the bed deck 116 is located below a head end of the mattress M for supporting the head end of the mattress M. Exemplary attachment configurations are described hereinbelow.

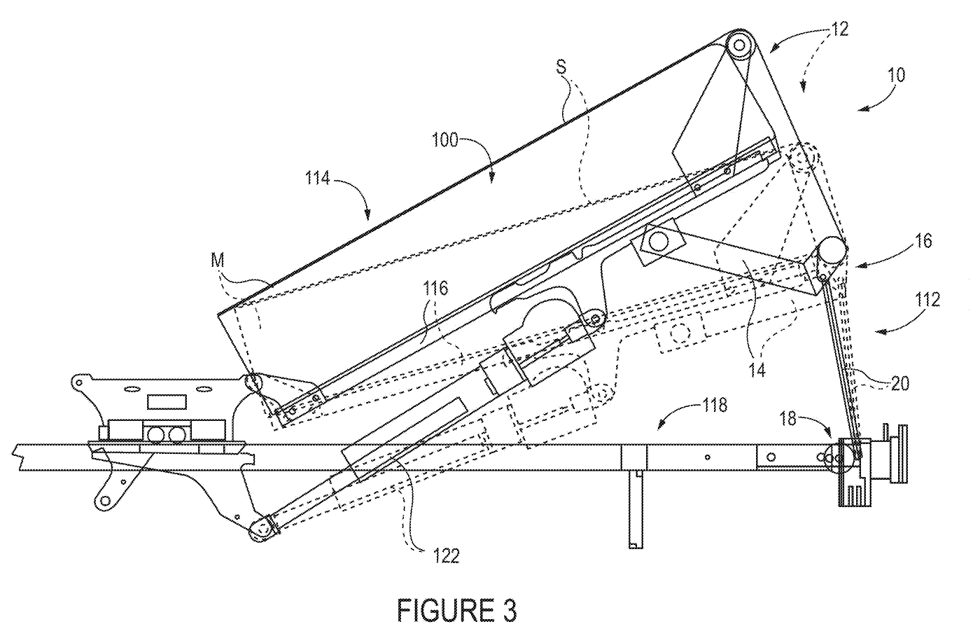

As shown in FIG. 3, the winder 18 may be supported by or relative to an upper frame 118 of the patient support apparatus 100, which supports the bed deck 116 for movement or articulation thereon. The winder 18 may control, including by locking and releasing, a connecting element such as a cable, wire, chain, rope or other suitable structure, referred to herein as cable or cables 20 for ease of reference. A single winder 18 may control a single cable 20. Alternatively, two laterally disposed cables 20 may be provided, one along each side of the bed deck 116. A single winder 18 may extend laterally relative to the bed deck 116 to control laterally disposed cables 20, or laterally disposed winders 18 may simultaneously control laterally disposed cables 20 along opposing sides of the bed deck 116.

In a boosting operation of the patient boosting or positioning device 10, the boosting sheet S is positioned beneath or relative to the patient on the mattress M (i.e., atop bedding, such as a fitted sheet and an absorbent pad) and supported relative to the bracket or brackets 14 or laterally extending structure 16. During normal operation of the patient support apparatus 100, the cable 20 may remain unlocked so that movement of the backrest section 114 relative to the upper frame 118, or movement of the upper frame 118 relative to the base frame 120, does not substantially move the sheet S. As the patient gradually migrates downward toward the foot end of the patient support apparatus 100, the sheet S may move concurrently with the patient while the cable 20 freely moves relative to the winder 18 or cable tensioning device 24.

When boosting or repositioning of the patient is desired, the cable 20 may be selectively locked relative to the upper frame 118 or base frame 120 through the winder 18, cable tensioning device 24 or locking element 34. Thereafter, movement of the backrest section 114 relative to the upper frame 118, or movement of the upper frame 118 relative to the base frame 120, causes corresponding movement of the bracket 14 and laterally extending structure 16, thereby pulling the sheet S toward the head end 112 of the patient support apparatus 100. Movement of the sheet S correspondingly boosts or repositions the patient supported thereon toward the head end 112 of the patient support apparatus 100.

In certain embodiments, the patient support apparatus 100 may simultaneously be positioned in a Trendelenburg orientation during operation of the patient positioning device 10 to reduce the force required to reposition the patient and improve patient comfort during the repositioning operation. Following completion of the repositioning operation, the cable 20 may again be released or unlocked to permit normal movement of the backrest section 114, upper frame 118 and sheet S during subsequent operation of the patient support apparatus 100. It should be appreciated that operation of the patient positioning device 10 is not limited to use in a Trendelenburg orientation and may additionally be performed while the patient support apparatus 100 remains in a substantially horizontal or non-Trendelenburg orientation.

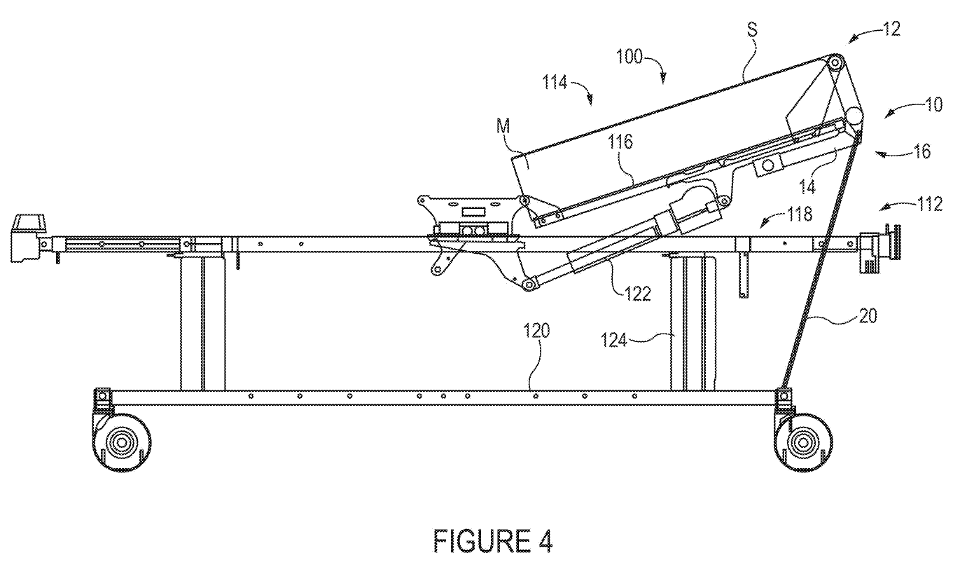

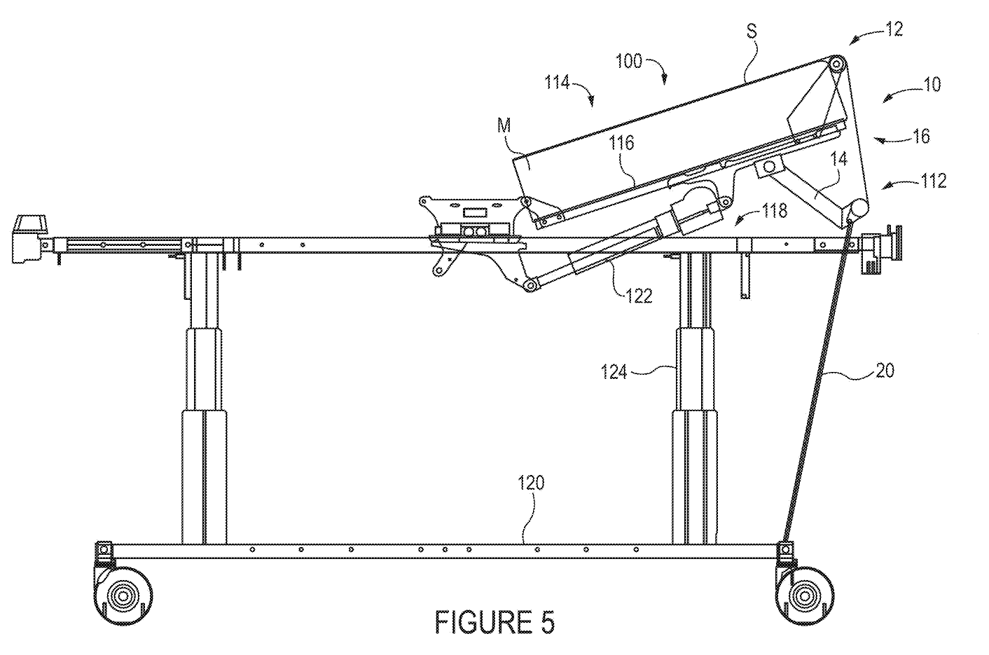

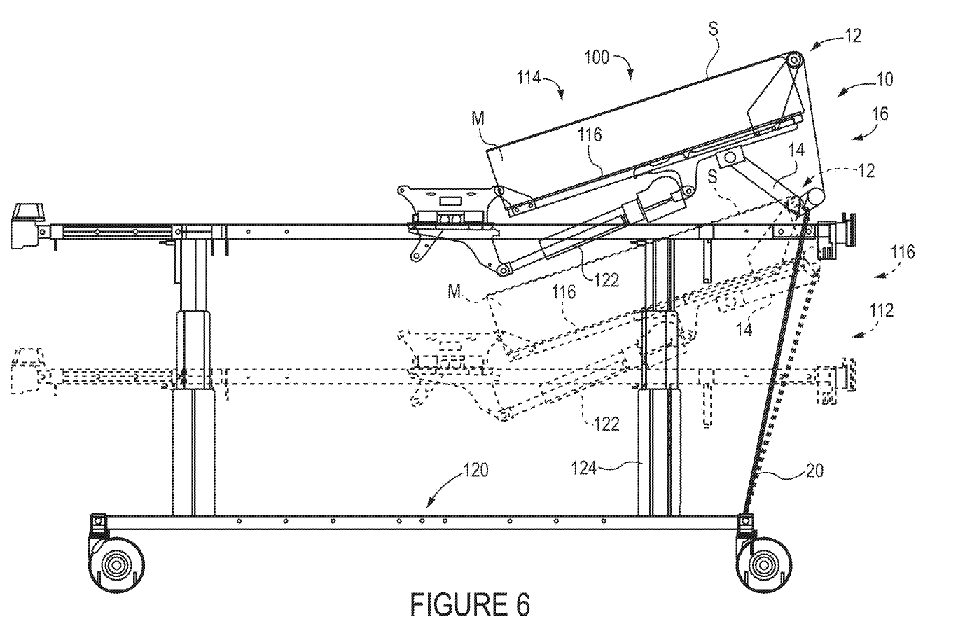

As illustrated in FIGS. 4-6, the cable or cables 20 may alternatively be supported relative to a chassis or base frame 120 of the patient support apparatus 100. In this configuration, the winder or winders 18 may be supported relative to the base frame 120. The base frame 120 may support the upper frame 118, and the upper frame 118 may be supported for movement, such as vertical movement, relative to the base frame 120. The cable or cables 20 may be connected to, or otherwise supported relative to, a free end of the bracket or brackets 14 opposite the end pivotally attached to, or supported relative to, the bed deck 116.

It should be appreciated that the cable 20 may be attached, connected or otherwise supported relative to components of the patient support apparatus 100 in a variety of suitable manners. For example, the cable 20 may be fixed through knots, clamps, crimps, swaged fittings, hooks, loops, eyelets, fasteners, pins, brackets, anchors, rivets, screws, bolts, weldments, adhesive connections or molded connections. In certain embodiments, the cable 20 may terminate in a fitting, connector or end stop configured for engagement with a corresponding support structure of the patient support apparatus. The cable 20 may additionally be coupled to one or more pulleys, guide pulleys, rollers, reels, winders, brackets or other moving or stationary support structures through direct attachment or indirect connection using intermediate links, couplers, straps, chains, belts or flexible members.

In either the embodiment shown in FIGS. 1-3 or the embodiment shown in FIGS. 4-6, when the winder or winders 18 are unlocked, the cable or cables 20 are free to move as the backrest section 114 of the bed deck 116, or alternatively the upper frame 118, is raised and lowered, without causing corresponding movement of the sheet S. When the winder or winders 18 are locked, the cable or cables 20 are prevented from moving as the backrest section 114 or the upper frame 118 is raised. In this locked condition, the cable or cables 20 pull the free end of the corresponding bracket or brackets 14 as the backrest section 114 or the upper frame 118 is raised. The sheet S, supported relative to the bracket or brackets 14, is thereby pulled to reposition a patient supported on the sheet S.

The winder or winders 18 may be selectively locked or otherwise restrained in a variety of suitable manners to prevent movement of the cable 20, sheet S or other flexible member during operation of the patient positioning device 10. For example, the winder 18 may comprise a pawl-and-ratchet mechanism, friction brake, spring-loaded locking mechanism, cam lock, pin lock, detent mechanism, clutch mechanism, electromagnetic brake, solenoid-actuated lock, motor brake, gear lock or other suitable rotational or translational locking arrangement. In certain embodiments, the locking mechanism may selectively prevent rotation of a reel, drum, spool or rotatable member associated with the winder 18. In other embodiments, the locking mechanism may directly engage the cable 20 or another portion of a tensioning system to prevent movement thereof. The locking mechanism may be manually actuated, electrically actuated, mechanically actuated, pneumatically actuated or automatically controlled through a controller or control unit associated with the patient support apparatus 100.

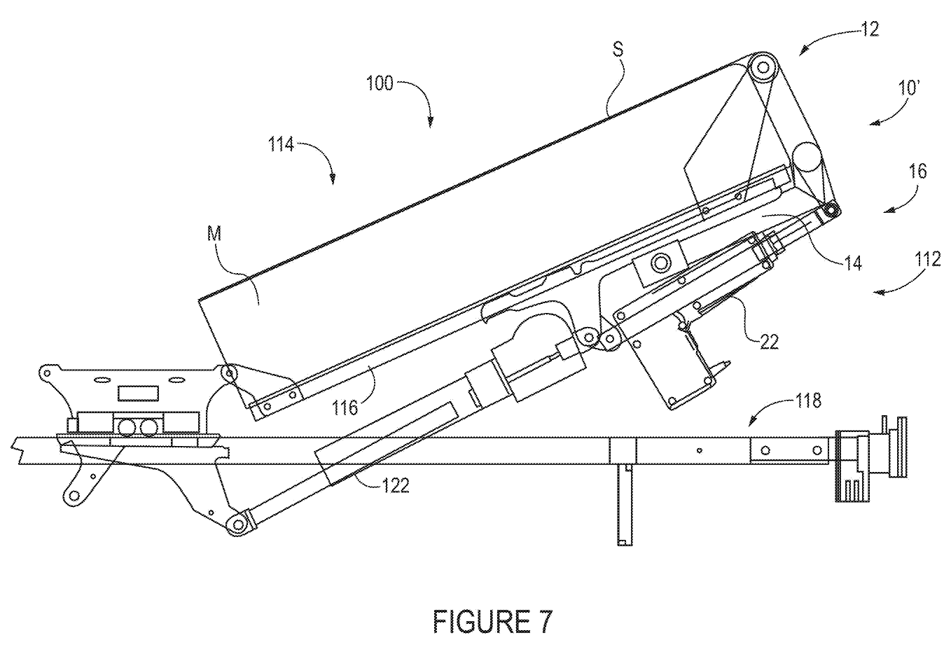

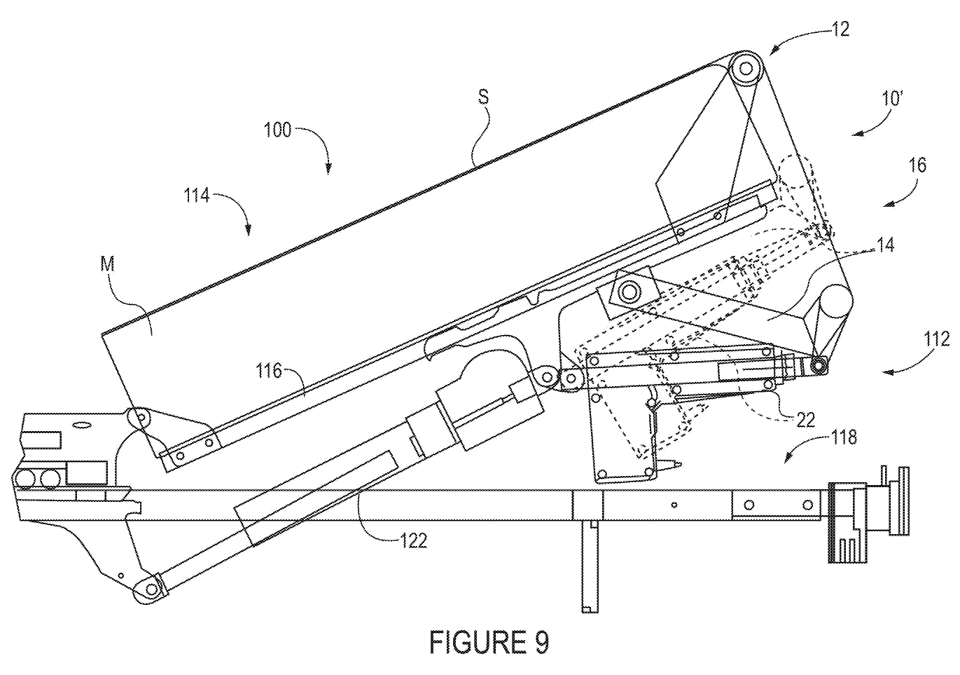

An alternative patient boosting or positioning device 10’ is shown in FIGS. 7-9. The patient positioning device 10’ comprises a drive mechanism 22, such as a linear actuator, having a first end connected to, or supported for pivotal movement relative to, the bed deck 116 and a second end connected to, or supported for pivotal movement relative to, the free end of the boosting bracket 14. Two drive mechanisms 22 and two brackets 14 may be provided, with each drive mechanism 22 connected to a corresponding bracket 14. Alternatively, a single drive mechanism 22 may be connected to the laterally extending structure 16, such as through a cantilevered structure, with the laterally extending structure 16 supported by laterally disposed brackets 14.

It should be appreciated that the drive mechanism 22 may comprise any suitable structure configured to move, pivot, rotate, translate, tension or otherwise actuate the bracket 14, laterally extending structure 16, boosting sheet S, cable 20 or other component of the patient positioning device 10’. In certain embodiments, the drive mechanism 22 may comprise a linear actuator, screw drive, lead screw actuator, ball screw actuator, rack-and-pinion actuator, hydraulic cylinder, pneumatic cylinder, telescoping actuator, electric cylinder, solenoid actuator, push-pull cable actuator or Bowden cable actuator. In other embodiments, the drive mechanism 22 need not comprise a linear drive and may instead comprise a rotary motor, gear train, crank arm, cam mechanism, eccentric drive, sector gear, winch, spool, drum, cable-and-pulley system, belt drive, chain drive, lever mechanism, four-bar linkage, scissor linkage, torsion spring arrangement, gas spring arrangement or other suitable mechanical, electrical, hydraulic or pneumatic actuation arrangement.

Opposing ends of the drive mechanism 22 may be attached, connected or otherwise supported relative to the patient positioning device 10’ or patient support apparatus 100 in a variety of suitable manners. For example, ends of the drive mechanism 22 may be connected through pins, shafts, axles, bolts, screws, rivets, brackets, clevis joints, hinge joints, spherical joints, rod ends, bearings, bushings, weldments, clamps, fasteners or other suitable connection structures permitting fixed or relative movement between connected components.

It should be appreciated that movement of the patient positioning devices described herein need not be effected by an independent drive mechanism 22. Instead, movement may be effected by movement of the bed deck 116, which is driven by a drive component 122 associated with the backrest section 114, as shown in FIGS. 1-3, or by movement of the upper frame 118 relative to the base frame 120, which is driven by one or more lifting columns 124 of the patient support apparatus 100, as shown in FIGS. 4-6.

An alternative patient positioning device 10’ is illustrated in FIGS. 7-9. Unlike the embodiments described above with reference to FIGS. 1-6, in which movement of the sheet S is produced through movement of the backrest section 114 relative to the upper frame 118 or movement of the upper frame 118 relative to the base frame 120, the patient positioning device 10’ utilizes an independent drive mechanism 22 configured to directly move the bracket 14 relative to the backrest section 114. The patient positioning device 10’ therefore may operate independently of articulated movement of the patient support apparatus 100 while still repositioning a patient supported on the sheet S toward the head end 112 of the patient support apparatus 100.

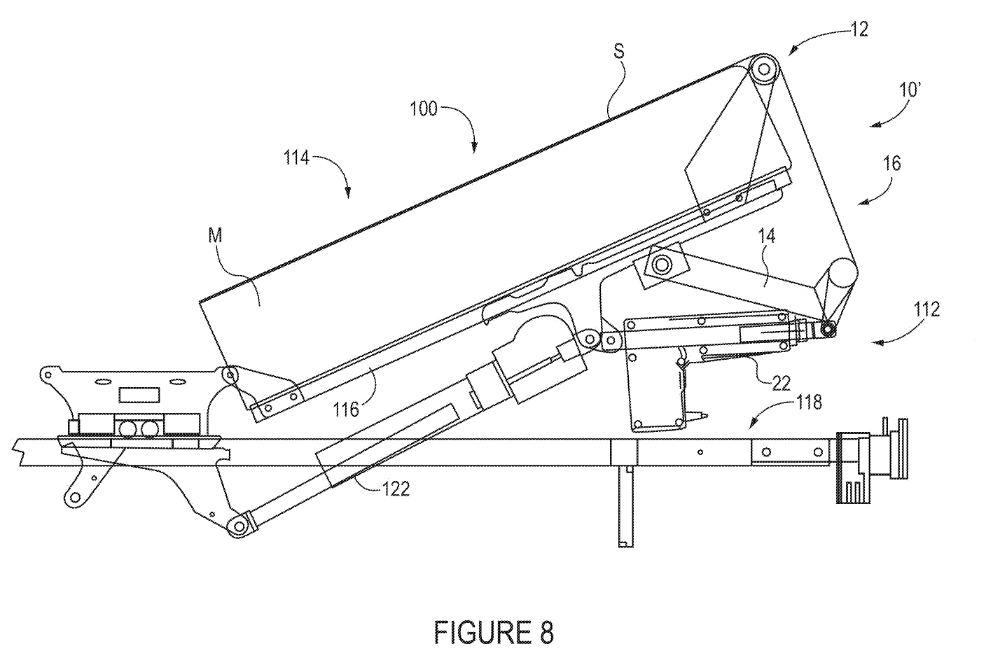

As shown in FIGS. 7-9, actuation of the drive mechanism or mechanisms 22 in a first direction causes extension of the drive mechanism or mechanisms 22 and movement of the bracket or brackets 14 adjacent to the bed deck 116. As shown in FIG. 8, actuation of the drive mechanism or mechanisms 22 in a second direction opposite the first direction retracts the drive mechanism or mechanisms 22, causing the bracket or brackets 14 to move away from the bed deck 116 and pull the sheet S. Pulling the sheet S in turn repositions a patient supported by the sheet S. Although a drive mechanism independent of the patient support apparatus 100 is not required in the embodiments of FIGS. 1-6, the embodiment of FIGS. 7-9 operates independently of any drive mechanism of the patient support apparatus 100.

In a boosting operation of the patient boosting or positioning device 10’, the boosting sheet S is positioned beneath or relative to the patient on the mattress M (i.e., atop bedding, such as a fitted sheet and absorbent pad) and supported relative to the bracket or brackets 14 or laterally extending structure 16. Unlike the embodiments described above with reference to FIGS. 1-6, in which movement of the sheet S is produced through movement of the backrest section 114 or upper frame 118 of the patient support apparatus 100, the patient positioning device 10’ utilizes an independent drive mechanism 22 to move the bracket 14 relative to the backrest section 114. The drive mechanism 22 may be actuated in a first direction to position the bracket or brackets 14 generally toward the backrest section 114. Upon actuation of the drive mechanism 22 in a second direction opposite the first direction, the drive mechanism 22 pivots or otherwise moves the bracket or brackets 14 relative to the backrest section 114 relative to the backrest section 114, thereby pulling the sheet S toward the head end 112 of the patient support apparatus 100. Movement of the sheet S correspondingly repositions the patient supported thereon toward the head end 112 of the patient support apparatus 100. In certain embodiments, the patient support apparatus 100 may simultaneously be positioned in a Trendelenburg orientation during operation of the patient positioning device 10’ to reduce the force required to reposition the patient and improve patient comfort during the boosting or repositioning operation. Following completion of the boosting or repositioning operation, the drive mechanism 22 may be actuated to return the bracket 14 toward an initial or home position, thereby preparing the patient positioning device 10’ for a subsequent repositioning operation. It should be appreciated that operation of the patient positioning device 10’ is not limited to use in a Trendelenburg orientation and may additionally be performed while the patient support apparatus 100 remains in a substantially horizontal or non-Trendelenburg orientation.

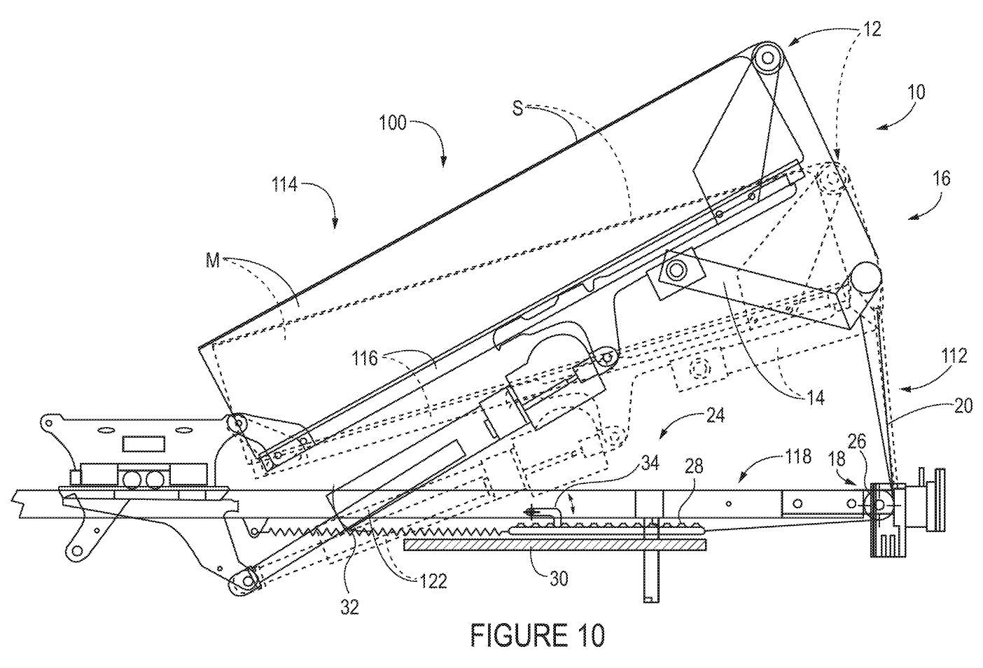

FIG. 10 illustrates an exemplary cable tensioning device 24, which may form the winder 18 or a portion of the winder used in connection with the patient positioning devices shown in FIGS. 1-6. The cable tensioning device 24 is configured to remove slack from the cable 20, maintain tension within the cable 20 during operation of the patient positioning device and selectively lock movement of the cable 20 during patient repositioning operations.

As shown in FIG. 10, an exemplary cable tensioning device 24 may form the winder 18 or a portion of the winder 18. The tensioning device 24 comprises a guide pulley 26 about which the cable 20 is guided. A free end of the cable 20 opposite the end connected to the bracket 14 may be connected to an end of a rack 28 comprising linearly disposed teeth defining grooves or recesses therebetween. The rack 28 is supported for movement relative to a track 30. An end of the rack 28 opposite the end connected to the cable 20 is connected to an end of an elastic member or spring 32, and an opposing end of the spring 32 is fixed against movement. In the illustrated embodiment, the opposing end of the spring 32 is connected to a tab supported in fixed relation to the upper frame 118. The spring 32 is placed in tension to pull the rack 28 and thereby remove slack from the cable 20 without pulling the sheet S or a patient supported on the sheet S. The track 30 is supported relative to the upper frame 118, and a locking element 34 is supported for pivotal movement relative to the upper frame 118 proximate the rack 28. In the illustrated embodiment, the locking element 34 comprises a pivotable tooth movable between a first position and a second position. In the first position, the tooth engages the rack 28 to lock the rack 28 in a fixed position, thereby preventing movement of the rack 28 and the cable 20. In the second position, the tooth is disengaged from the rack 28, thereby permitting movement of the rack 28 and the cable 20. In the locked position, raising the backrest section 114 of the patient support apparatus 100 pulls the sheet S and correspondingly repositions the patient supported thereon.

Although the winder 18 and cable tensioning device 24 are illustrated in certain embodiments as comprising the rack 28, spring 32 and locking element 34 arrangement described herein, other suitable winding, retracting, tensioning or slack-removal structures may be employed. For example, the winder 18 or cable tensioning device 24 may comprise a spring-loaded reel, spool, drum, winch, take-up reel, retractable cable reel, seatbelt-style retractor, torsion spring mechanism, constant-force spring mechanism, elastic tensioning device, pulley-and-counterweight arrangement, motor-driven reel, gear-driven tensioning mechanism, friction-based take-up mechanism, hydraulic tensioning device, pneumatic tensioning device, ratcheting take-up mechanism, clutch-controlled reel, belt tensioner, chain tensioner or other structure configured to remove slack from, tension, retract, wind or otherwise control movement of the cable 20 or another flexible member associated with the patient positioning device. In certain embodiments, such structures may operate passively to maintain tension within the cable 20, while in other embodiments such structures may be actively driven or controlled through mechanical, electrical, hydraulic or pneumatic actuation systems.

Although the locking element 34 is illustrated as a pivotable tooth engageable with the rack 28, other suitable locking structures may be employed. For example, the locking element 34 may comprise a pawl, latch, detent, pin, clamp, brake, cam lock, wedge lock, ratchet mechanism, clutch, solenoid-actuated lock, electromagnetic brake, friction brake, gear lock, over-center lock, spring-biased lock or other structure configured to selectively prevent movement of the rack 28, cable 20 or another portion of the cable tensioning device 24. In certain embodiments, the locking element 34 may directly engage the rack 28. In other embodiments, the locking element 34 may engage the cable 20, guide pulley 26, winder 18, track 30 or another movable component to selectively prevent movement of the cable 20.

It should be appreciated that the pulley 12 may extend laterally across the width of the patient support apparatus 100 but need not do so. Moreover, the pulley 12 may be omitted where the mattress M, sheet S or associated support surfaces provide sufficiently low friction to permit relative movement therebetween. Other suitable guide structures, including those described above with reference to the patient positioning device 10, may additionally be employed to direct, support or reduce friction associated with movement of the sheet S, cable 20 or another flexible member during operation of the patient positioning device.

The bracket or brackets 14 supporting the laterally extending structure 16 may be formed in a variety of suitable structural configurations. In certain embodiments, the bracket or brackets 14 and laterally extending structure 16 may be formed as a single integral component, such as a U-shaped weldment, tubular frame, bent rod structure, cast structure, molded structure or fabricated assembly. In one embodiment, the U-shaped structure may comprise a pair of laterally spaced structural members extending from opposing lateral sides or edges of the backrest section 114. First ends of the laterally spaced structural members may be pivotally attached to, or otherwise supported relative to, the backrest section 114 through hinges, pivot joints, pins, shafts, axles, bearings, bushings, brackets, clevis joints, linkage structures or other suitable support arrangements permitting relative movement between the brackets 14 and the backrest section 114. Opposing second ends of the laterally spaced structural members may be connected by the laterally extending structure 16 extending generally across at least a portion of the width of the mattress M such that movement of the brackets 14 causes corresponding movement of the laterally extending structure 16 and the sheet S supported thereby.

Alternatively, the bracket 14 and laterally extending structure 16 may together define a generally T-shaped structure. For example, the bracket 14 may comprise a laterally centered structural member extending from the backrest section 114 toward the head end 112 of the patient support apparatus 100. A first end of the laterally centered structural member may be pivotally attached to, or otherwise supported relative to, the backrest section 114 through hinges, pivot joints, shafts, pins, axles, bearings, bushings, brackets, linkage structures or other suitable support arrangements. An opposing second end thereof may be fixed, coupled or otherwise supported relative to the laterally extending structure 16 such that the bracket 14 and laterally extending structure 16 move together during operation of the patient positioning device. In other embodiments, the laterally centered structural member may be fixed relative to the backrest section 114 while the laterally extending structure 16 is pivotally supported relative thereto.

It should be appreciated that the brackets 14 and laterally extending structure 16 are not limited to U-shaped or T-shaped arrangements and may comprise other suitable structural configurations, including Y-shaped structures, H-shaped structures, wishbone structures, articulated structures, telescoping structures, cantilevered support arrangements, dual-arm support arrangements, curved support members, cable-supported structures or other suitable frame or support arrangements configured to support and move the sheet S during operation of the patient positioning device.

The cable 20 may be fixed to the upper frame 118 or to the base frame 120 of the patient support apparatus 100. Two cables 20 may be provided, with each cable 20 attached or supported relative to a respective lateral side of the patient support apparatus 100. Alternatively, a single cable 20 may preferably be provided between the lateral sides of the patient support apparatus 100. Although certain embodiments describe a connecting element as a cable 20, other suitable flexible or force-transmitting structures may be employed. For example, the connecting element may comprise a wire, rope, cord, strap, belt, chain, tether, filament, band, webbing, flexible linkage, Bowden cable, flexible shaft, braided member, textile member, reinforced polymeric member, composite member or other suitable structure configured to transmit tension, pulling force or movement between components of the patient positioning device. In certain embodiments, the connecting element may comprise metallic, polymeric, textile, elastomeric, composite or hybrid materials and may be flexible, semi-flexible or articulated depending upon the intended application and operational characteristics of the patient positioning device.

The cable 20 may be attached, connected or otherwise supported relative to components of the patient positioning device or patient support apparatus in a variety of suitable manners. For example, ends or intermediate portions of the cable 20 may be connected through knots, loops, eyelets, hooks, clips, clamps, crimps, swaged fittings, ferrules, sleeves, pins, brackets, anchors, fasteners, rivets, screws, bolts, weldments, adhesive connections, molded connections or other suitable attachment structures. In certain embodiments, the cable 20 may terminate in a fitting, connector, end stop, clevis, threaded fitting, coupler or other terminal structure configured for engagement with a corresponding support structure. The cable 20 may additionally be directly attached to a component of the patient positioning device or indirectly connected through intermediate links, chains, straps, belts, pulleys, reels, winders, brackets, springs or other force-transmitting or guiding structures.

The winder 18 may be fixed to the upper frame 118 or to the base frame 120 of the patient support apparatus 100. Two winders 18 may be provided, with each winder 18 attached or supported relative to a respective lateral side of the patient support apparatus 100. Alternatively, a single winder 18 may be provided between the lateral sides of the patient support apparatus 100.

It should be understood that the invention may include other structures and is not limited to the structures described herein. For example, the cable 20 is preferably retractable to remove slack from the cable 20. Once the cable 20 is pulled from the winder 18 as the backrest section 114 is raised, the cable 20 may retract as the backrest section 114 is lowered to remove slack in the cable 20. Such a retraction feature is not limited to the cable tensioning device 24 shown in FIG. 10, and may be accomplished by other suitable structures, including one or more motors controlled simultaneously, a spring or another elastic member tensioned when the backrest section 114 is raised and configured to recoil or retract the cable 20 when the backrest section 114 is lowered.

Depending on the structural configuration of the winder 18, the winder 18 may be configured to pull the bracket 14 without independently pulling the sheet S, such that movement of the sheet S is limited to movement caused by the backrest section 114 or the upper frame 118 of the patient support apparatus 100.

The winder 18 may comprise a structure configured to wind, retract, tension or otherwise control movement of the cable 20. Such structure need not include an actuator, such as a motor, for winding the cable 20. For example, the winder 18 may comprise a retractable spring mechanism, constant-force spring mechanism or other passive tensioning arrangement, similar to a seat belt retractor, configured to wind and release the cable 20 as needed to remove slack and maintain tension within the cable 20 during operation of the patient positioning devices described herein.

In a preferred embodiment, the winder 18 does not independently pull the sheet S. For example, if the patient exits the patient support apparatus 100, the sheet S is not unintentionally pulled. The winder 18 may include a safeguard that prevents the winder 18 from functioning in any way other than keeping the cable 20 taut, meaning the winder 18 does not create a pulling force sufficient to move the sheet S relative to the mattress M. Such a winder 18 may be tuned or otherwise configured to prevent the sheet S from being pulled by the cable 20 without movement of the backrest section 114 or the upper frame 118, so only slack in the cable 20 is removed.

The winder 18 may include a housing with an elastic member therein for retracting the cable 20 into the housing, without requiring the cable 20 to be wound around a spool or drum. To be clear, the winder 18 is not intended to be limited to a structure that winds the cable 20 but is intended to broadly include any structure configured to remove slack from the cable 20.

It should further be appreciated that the bracket or brackets 14 may be operatively connected to a spring or other suitable structure to move the bracket or brackets 14 to a retracted position adjacent the backrest section 114. In such a case, the winder 18 may be structured to avoid pulling the bracket or brackets 14 downward so as to cause the bracket or brackets 14 to dangle downward from the backrest section 114. In a preferred embodiment, the winder 18 has insufficient force to pull the bracket or brackets 14 downward into a dangling position relative to the backrest section 114.

It should be understood that pulling or movement of the bracket or brackets 14 may be achieved by raising the backrest section 114 or by lifting the upper frame 118 of the patient support apparatus 100, as shown in FIG. 10. Movement of the bracket or brackets 14 may also be effected by any suitable driven movement of the patient support apparatus 100, including movement associated with raising, lowering or tilting another section of the bed deck 116, such as a footrest section. Thus, pulling or movement of the bracket 14 may be achieved by movement of the patient support apparatus 100.

In operation of the cable tensioning device 24 shown in FIG. 10, the cable 20 is guided about the guide pulley 26 and connected to the rack 28 supported for movement relative to the track 30. The spring 32 biases the rack 28 in a direction tending to pull the cable 20, thereby removing slack from the cable 20 and maintaining tension therein during normal operation of the patient support apparatus 100. While the locking element 34 is in an unlocked position, the rack 28 is permitted to move relative to the track 30 so that the cable 20 may move freely during articulation of the patient support apparatus 100 without substantially pulling the boosting sheet S. When boosting or repositioning of a patient is desired, the locking element 34 may be moved into engagement with the rack 28 to prevent movement of the rack 28 relative to the track 30. Once the rack 28 is locked, movement of the backrest section 114 relative to the upper frame 118, or movement of the upper frame 118 relative to the base frame 120, tensions the cable 20 and causes corresponding movement of the boosting bracket or brackets 14 and the sheet S, thereby repositioning the patient toward the head end 112 of the patient support apparatus 100. Following completion of the repositioning operation, the locking element 34 may again be disengaged from the rack 28 to permit free movement of the cable 20 during subsequent operation of the patient support apparatus 100.

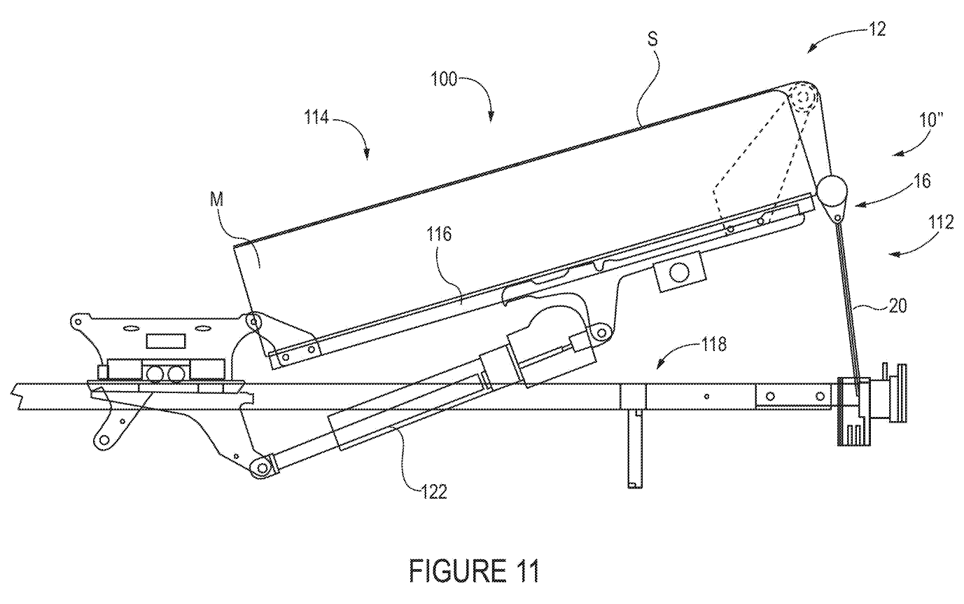

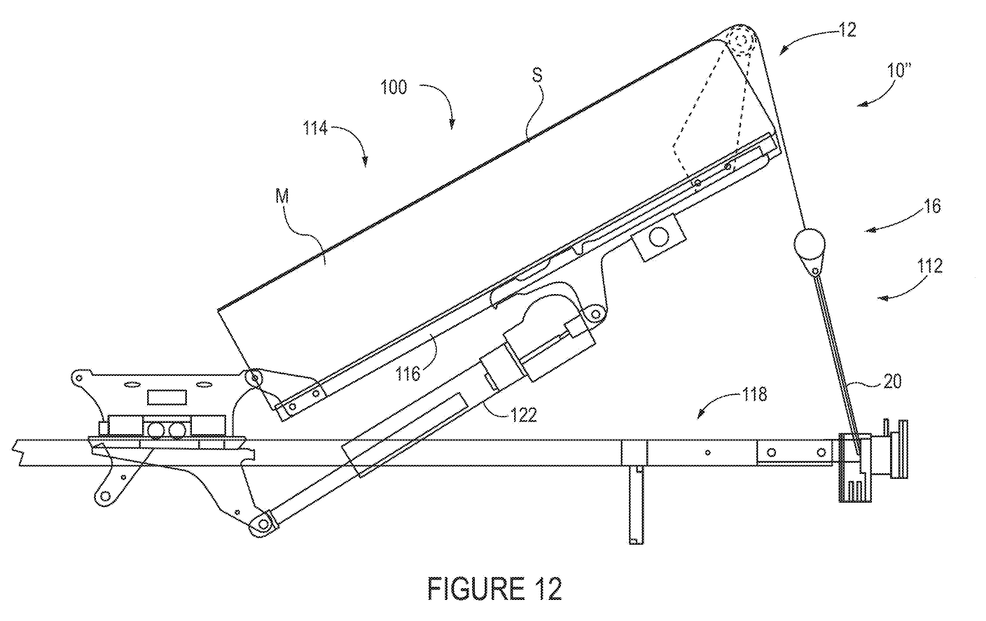

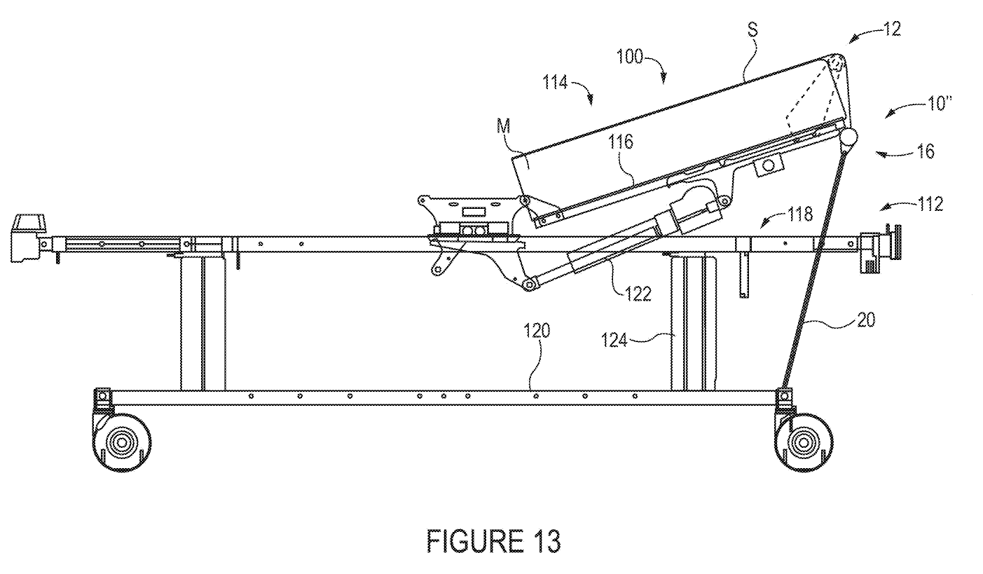

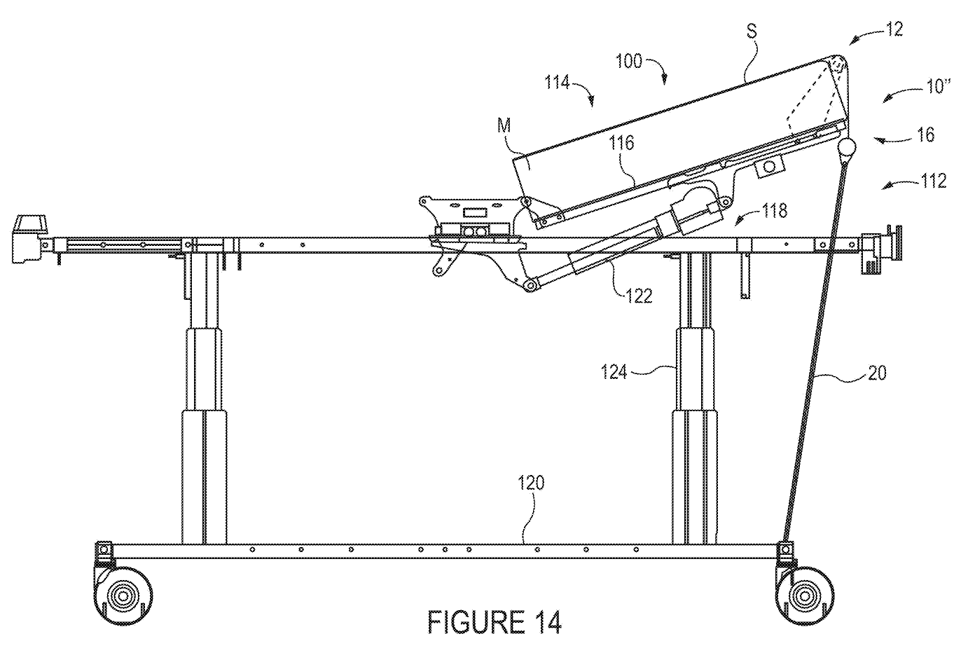

As shown in FIGS. 11-14, another exemplary patient boosting or positioning device 10’’ need not comprise a bracket or a pulley, the pulley being shown optionally in broken line in FIGS. 11-14. The patient positioning device 10’’ may nevertheless operate in the same general manner described above with reference to FIGS. 1-6. In this embodiment, the boosting sheet S may be supported directly or indirectly by or relative to the cable 20, which may in turn be attached to a winder similar to the winder 18 described above with reference to FIG. 10.

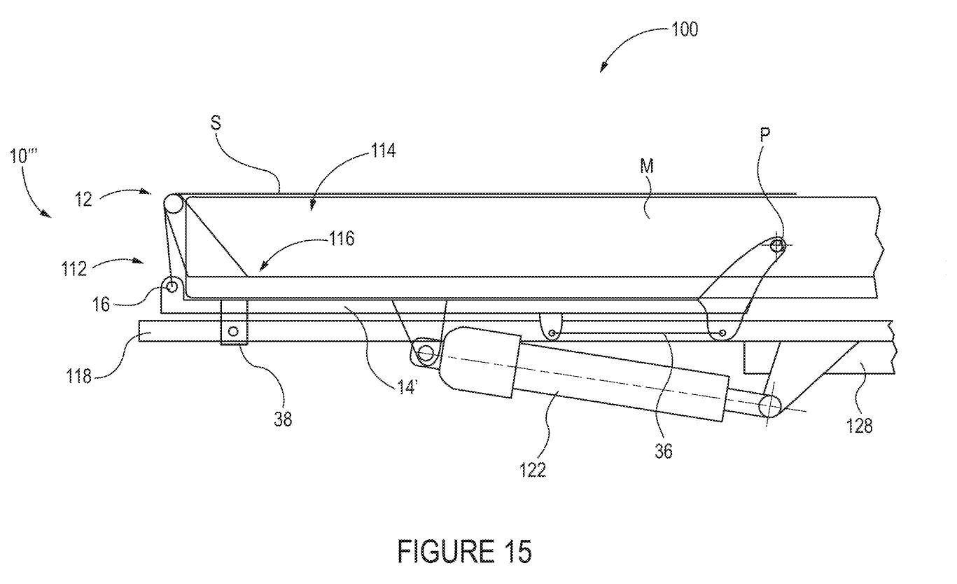

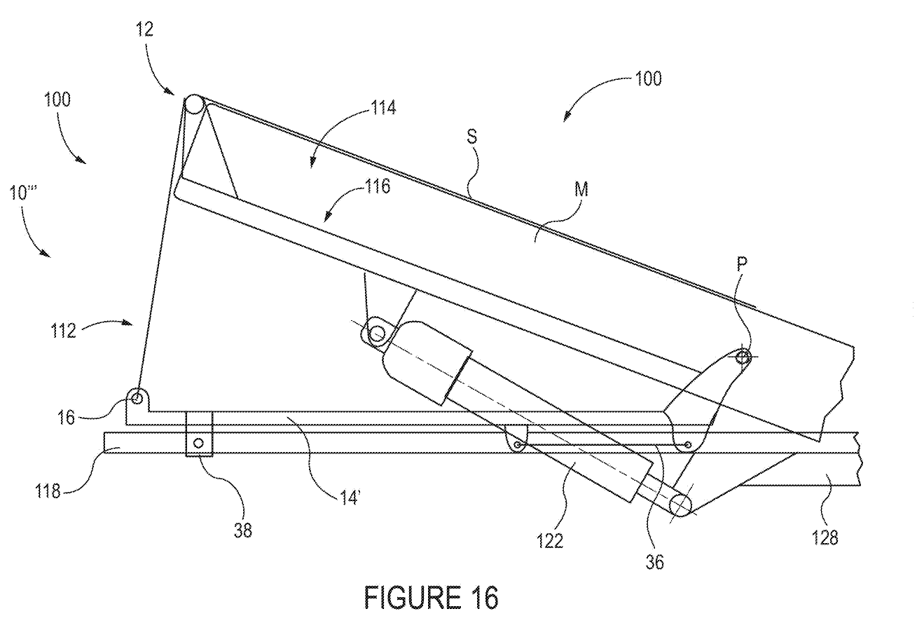

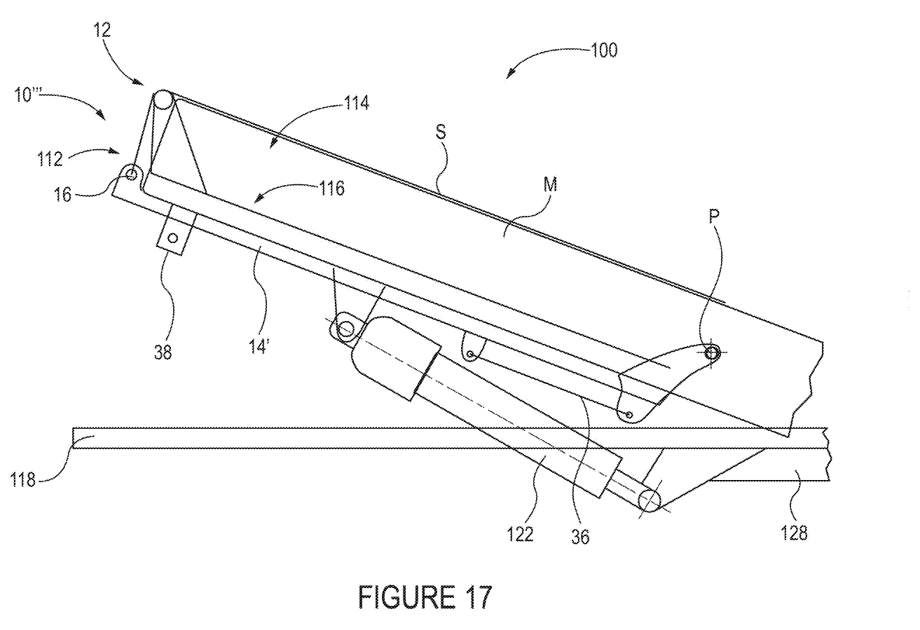

Another patient positioning device 10’’’ is illustrated in FIGS. 15-17. Unlike the embodiments described above with reference to FIGS. 1-14, the patient positioning device 10’’’ comprises a bracket or brackets 14’ supported for movement relative to the backrest section 114 and biased toward the backrest section 114 by a biasing element 36. The bracket or brackets 14’ may selectively be locked relative to the patient support apparatus 100 through a locking element 38 during patient boosting or repositioning operations. Movement of the backrest section 114 relative to the patient support apparatus 100 while the bracket or brackets 14’ are locked causes movement of the boosting sheet S to boost or reposition a patient supported thereon toward the head end 112 of the patient support apparatus 100.

As shown in FIGS. 15-17, the patient positioning device 10’’’ may comprise a bracket or brackets 14’ pivotally supported relative to the backrest section 114 about a pivot point P of the bed deck 116, without requiring a cable. In the illustrated embodiment, the bracket or brackets 14 are normally biased toward the backrest section 114 by the biasing element 36, such as a gas spring or other suitable element. The locking element 38 associated with the bracket or brackets 14 may be operated by a control unit 128 of the patient support apparatus 100, such as through suitable programming, together with movement of the backrest section 114. This may occur, for example, by operation of a button or other suitable control actuated by a caregiver to raise the backrest section 114, so that the bracket or brackets 14’ are automatically operated as well. The sheet S may be pulled as the backrest section 114 moves upwardly from a substantially horizontal position.

The patient positioning device 10’’’ may comprise one or more brackets 14’ supported for movement relative to the backrest section 114. In certain embodiments, a single centrally disposed bracket 14’ may be provided. In other embodiments, laterally spaced brackets 14’ may be provided adjacent opposing lateral sides of the backrest section 114 and may support a laterally extending structure 16 therebetween for supporting the sheet S. The bracket or brackets 14’ may be pivotally attached to, or otherwise supported relative to, the backrest section 114 through hinges, pivot joints, pins, shafts, axles, bearings, bushings, linkage structures or other suitable support arrangements permitting relative movement between the bracket or brackets 14’ and the backrest section 114.

The bracket or brackets 14’ may be biased toward the backrest section 114 by one or more biasing elements 36. Exemplary biasing elements 36 may include gas springs, coil springs, torsion springs, leaf springs, elastic members, resilient polymeric members, counterweights, pneumatic biasing devices, hydraulic biasing devices or other suitable resilient or force-generating structures configured to bias the bracket 14’ toward a desired position relative to the backrest section 114. In certain embodiments, the biasing element 36 may additionally provide damping characteristics to reduce abrupt movement of the bracket 14’ during operation of the patient positioning device 10’’’.

The bracket or brackets 14’ may additionally be selectively secured relative to the patient support apparatus 100 through one or more locking elements 38. Exemplary locking elements 38 may include latches, pawls, pins, detents, catches, clamps, hooks, ratchet mechanisms, friction brakes, cam locks, solenoid-actuated locks, electromagnetic locks, over-center locking mechanisms or other suitable structures configured to selectively prevent movement of the bracket or brackets 14’ relative to the patient support apparatus 100. In certain embodiments, operation of the locking element 38 may be coordinated with movement of the backrest section 114 through the controller or control unit 128 associated with the patient support apparatus 100.

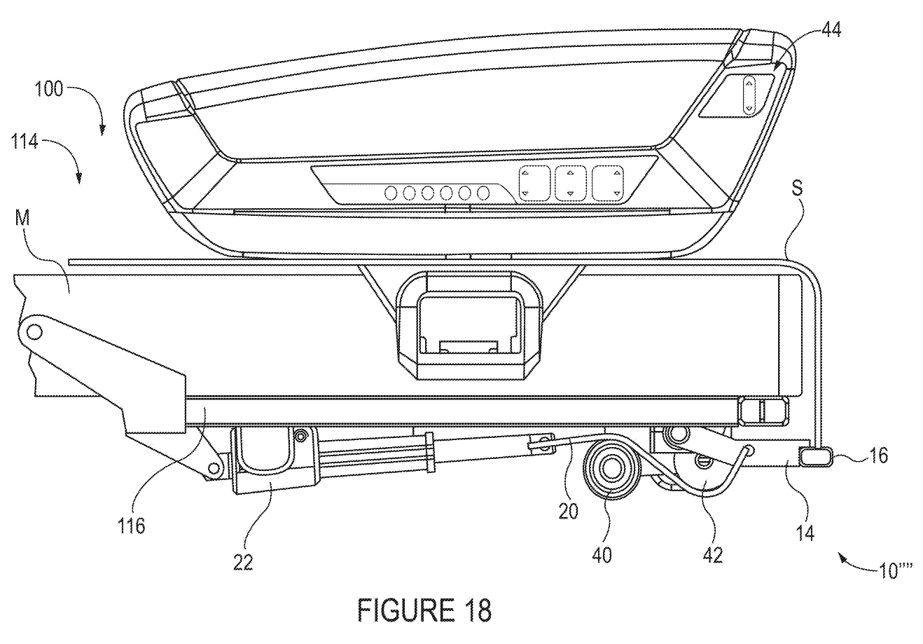

Operation of the patient positioning device 10’’’ may be initiated through one or more buttons, switches or other user inputs positioned at suitable locations on the patient support apparatus 100. For example, one or more control buttons (e.g., “BOOST ON” or “BOOST OFF”) may be positioned on a siderail 126, caregiver control panel, pendant controller, footboard, headboard or another accessible portion of the patient support apparatus 100. In certain embodiments, the control unit 128 may be integrated into or associated with a siderail 126 proximate the head end 112 of the patient support apparatus 100, similar to the controller or control unit 44 described below with reference to FIGS. 18-20, thereby allowing a caregiver to maintain visual contact with the patient during operation of the patient positioning device 10’’’.

In operation of the patient boosting or positioning device 10’’’, the boosting sheet S is positioned beneath or relative to the patient on the mattress M (i.e., atop bedding, such as a fitted sheet and absorbent padding) and supported relative to the boosting the bracket or brackets 14’ and/or laterally extending structure 16 associated therewith. During normal operation of the patient support apparatus 100, the bracket or brackets 14’ may remain generally biased toward the backrest section 114 by the biasing element 36 while the locking element 38 remains disengaged, thereby permitting normal articulation of the backrest section 114 without substantially pulling the sheet S. As the patient gradually migrates downward toward the foot end of the patient support apparatus 100, the sheet S may move concurrently with the patient relative to the mattress M.

When boosting or repositioning of the patient is desired, the locking element 38 may be actuated to selectively secure the bracket or brackets 14’ relative to the patient support apparatus 100. Once the bracket or brackets 14’ is locked, movement of the backrest section 114 relative to the patient support apparatus 100 causes corresponding movement of the sheet S relative to the mattress M, thereby repositioning the patient toward the head end 112 of the patient support apparatus 100. In certain embodiments, the patient support apparatus 100 may simultaneously be positioned in a Trendelenburg orientation during operation of the patient positioning device 10’’’ to reduce the force required to reposition the patient and improve patient comfort during the boosting or repositioning operation.

Following completion of the repositioning operation, the locking element 38 may be disengaged to permit the bracket or brackets 14’ to again move relative to the backrest section 114 under the influence of the biasing element 36, thereby returning the patient positioning device 10’’’ toward a normal operating condition and preparing the patient positioning device 10’’’ for a subsequent repositioning operation. It should be appreciated that operation of the patient positioning device 10’’’ is not limited to use in a Trendelenburg orientation and may additionally be performed while the patient support apparatus 100 remains in a substantially horizontal or non-Trendelenburg orientation.

Another patient boosting or positioning device 10’’’’ is illustrated in FIGS. 18-20. The patient positioning device 10’’’’ builds upon the drive mechanism 22 described above with reference to the patient positioning device 10’ shown in FIGS. 7-9. The patient boosting or positioning device 10’ described above comprises a direct connection between the drive mechanism 22 and the boost bracket or brackets 14 to pull the boost sheet S. While mechanically effective, the patient positioning device 10’ requires the drive mechanism 22 to pivot together with the bracket or brackets 14, thereby requiring a relatively large operational envelope and substantial clearance within the chassis or base frame 120 of the patient support apparatus 100. Due to space limitations within the base frame 120, the patient positioning device 10’’’’ provides a more compact arrangement. In the patient positioning device 10’’’’, the bracket or brackets 14 are actuated through a cable or belt 20 rather than being directly coupled to the drive mechanism 22. The cable or belt 20 may be routed through a pulley system or block-and-tackle arrangement, such as a pulley system utilizing multiple pulleys with a flexible member, which may comprise cable, belt, rope, or cord, to obtain a mechanical advantage.

In the illustrated embodiment of the patient positioning device 10’’’’, one end of the drive mechanism 22 is connected to or supported relative to the bed deck 116 of the patient support apparatus 100. A first end of the cable or belt 20 is connected to or supported relative to an opposite end of the drive mechanism 22. A second end of the cable or belt 20 is connected to or supported relative to the boosting bracket 14. The cable or belt 20 passes over one pulley 40 and under another pulley 42 in a serpentine arrangement extending between the drive mechanism 22 and the bracket or brackets 14. The pulleys 40 and 42 may be supported relative to the patient support apparatus 100, the bracket or brackets 14, the bed deck 116 or another structural component of the patient support apparatus 100. The bracket or brackets 14 in turn support or are connected relative to the laterally extending structure 16 to which the sheet S is connected.

The patient positioning device 10’’’’ is preferably configured to operate only when the backrest section 114 is positioned within an inclination range of approximately 0° to 30° from horizontal. The angular position of the backrest section 114 may be monitored through a limit switch or angle sensor to ensure safe operating conditions. If the inclination of the backrest section 114 exceeds approximately 30°, operation of the patient positioning device 10’’’’ may be automatically inhibited or disabled to preserve patient safety and protect mechanical components from excessive loading. As shown in FIGS. 18-20, a controller or control unit 44 may be integrated into a siderail 126 of the patient support apparatus 100 near the head end 112 of the patient support apparatus 100 to allow an operator to maintain direct visual contact with a patient during operation. To prevent unintended activation, the controller or control unit 44 may incorporate a safety lockout that remains engaged until intentionally released by the operator.

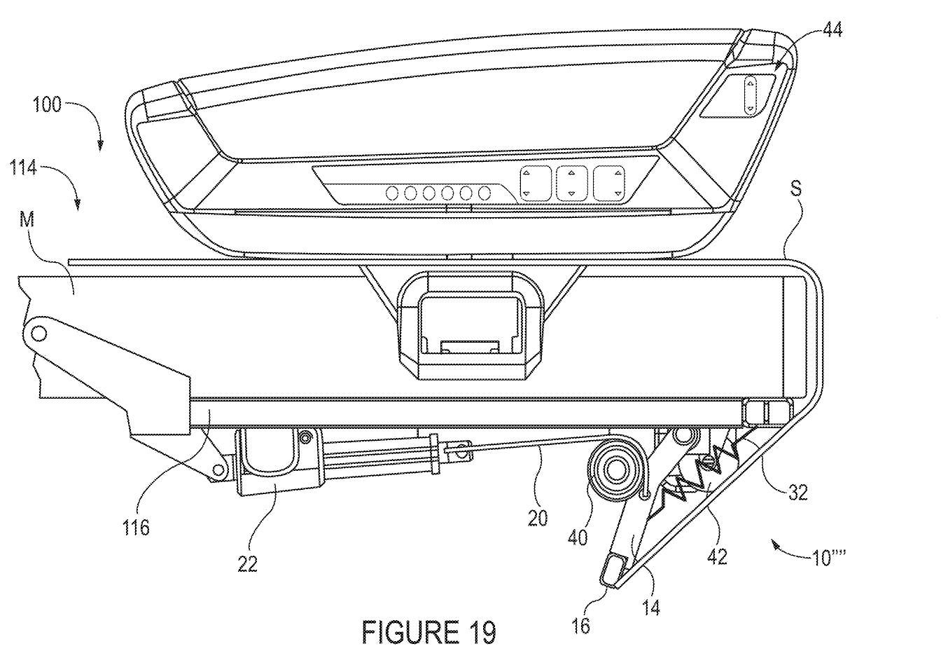

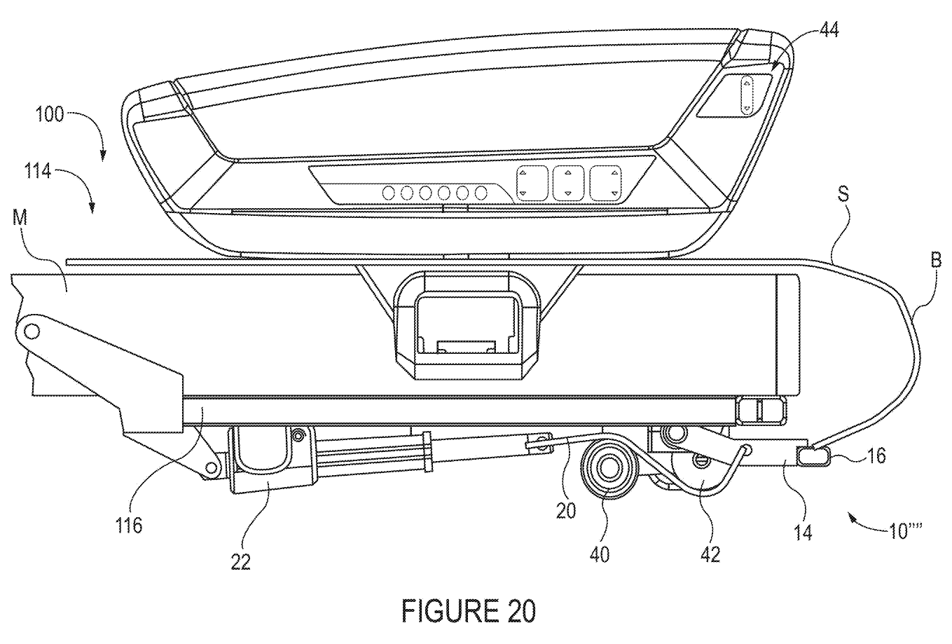

In FIG. 18, the patient boosting or positioning device 10’’’’ is in an initial position. During a boosting operation, the drive mechanism 22 applies tension to the cable or belt 20, thereby pivoting the bracket 14 and pulling the sheet S to reposition a patient toward the head end 112 of the patient support apparatus 100, as illustrated in FIG. 19. The displacement distance, or stroke length (i.e., how far the sheet S pulled), may be manually controlled by the operator. A return spring or resilient return element 46 may automatically return the bracket 14 to the initial position upon release of the actuation force. Following completion of a patient positioning operation, the operator may reset the patient positioning device 10’’’’ by pressing a second designated control input on the controller or control unit 44, thereby returning the bracket 14 toward a home or baseline position. As illustrated in FIG. 20, as the bracket 14 retracts, excess material of the sheet S is released behind the patient, thereby creating a slack region or bubble B within the sheet S.

It should be appreciated that, simultaneously with movement of the backrest section 114, the support deck frame 118 may be tilted into a Trendelenburg position to assist repositioning of the patient by reducing the force required for movement of the patient and increasing patient comfort during the boosting or positioning operation.

As the patient lies on the patient support apparatus 100, the patient and the sheet S may naturally migrate downward toward the foot end of the patient support apparatus 100 under the influence of gravitational forces. As the patient moves downward, the sheet S moves concurrently, thereby consuming the slack region or bubble B previously created during the reset procedure shown in FIG. 20. Once the slack region or bubble B has been substantially removed and the sheet S is again taut, the patient positioning device 10’’’’ may be prepared for a subsequent positioning operation.

The drive mechanism 22 may comprise any suitable structure configured to move, pivot, rotate, tension or otherwise actuate the bracket or brackets 14 of the patient positioning device 10’’’’. In certain embodiments, the drive mechanism 22 may comprise a linear actuator, screw drive, lead screw actuator, ball screw actuator, rack-and-pinion actuator, hydraulic cylinder, pneumatic cylinder, telescoping actuator, electric cylinder, solenoid actuator, push-pull cable actuator or Bowden cable actuator. In other embodiments, the drive mechanism 22 need not comprise a linear drive and may instead comprise a rotary motor, gear train, crank arm, cam mechanism, eccentric drive, sector gear, winch, spool, drum, cable-and-pulley system, belt drive, chain drive, lever mechanism, four-bar linkage, scissor linkage, torsion spring arrangement, gas spring arrangement or another suitable mechanical, electrical, hydraulic or pneumatic actuation arrangement. Opposing ends of the drive mechanism 22 may be attached, connected or otherwise supported relative to the patient positioning device 10’’’’ or patient support apparatus 100 through pins, shafts, axles, bolts, screws, rivets, brackets, clevis joints, hinge joints, spherical joints, rod ends, bearings, bushings, weldments, clamps, fasteners or other suitable connection structures permitting fixed or relative movement between connected components.

Although certain embodiments describe the flexible member of the cable or belt drive system as a cable or belt 20, other suitable force-transmitting structures may be employed. For example, the cable or belt 20 may comprise a wire, rope, cord, strap, webbing, band, chain, tether, Bowden cable, flexible shaft, braided member, textile member, reinforced polymeric member, composite member or another suitable flexible or semi-flexible structure configured to transmit tension, pulling force or movement between components of the patient positioning device 10’’’’. In certain embodiments, the cable or belt 20 may comprise metallic, polymeric, textile, elastomeric, composite or hybrid materials, including steel, stainless steel, nylon, polyester, polypropylene, aramid fibers, carbon-fiber-reinforced materials or elastomeric materials configured to withstand repeated loading, tensioning and movement during operation of the patient positioning device 10’’’’. The cable or belt 20 may have a first end connected or supported relative to the drive mechanism 22 and a second end connected or supported relative to the bracket or brackets 14. The cable or belt 20 may be attached, coupled or otherwise supported relative to the drive mechanism 22 and the bracket or brackets 14 through knots, loops, eyelets, hooks, clips, clamps, crimps, swaged fittings, ferrules, sleeves, pins, brackets, anchors, fasteners, rivets, screws, bolts, weldments, adhesive connections, molded connections or other suitable attachment structures.

The cable or belt 20 may be routed directly or through one or more pulleys 40 and 42, guide structures or block-and-tackle arrangements. The pulley arrangement may provide a variety of operational advantages, including mechanical advantage, reduced force requirements for the drive mechanism 22, increased effective stroke length, improved routing flexibility of the cable or belt 20 within the patient support apparatus 100, reduced loading applied to moving components and reduced operational space requirements within the chassis or base frame 120. The pulleys 40 and 42 may be supported relative to the patient support apparatus 100, the bracket or brackets 14, the bed deck 116, the upper frame 118, the base frame 120 or another structural component of the patient support apparatus 100.

The bracket or brackets 14 of the patient positioning device 10’’’’ may comprise a variety of suitable structural configurations configured to support and move the boosting sheet S during operation of the patient positioning device 10’’’’. For example, the bracket or brackets 14 may comprise generally T-shaped, U-shaped, H-shaped, Y-shaped, wishbone-shaped, arcuate, segmented, articulated or other suitable support arrangements. The bracket or brackets 14 may be formed as welded structures, tubular frames, bent rod structures, cast structures, molded structures, fabricated assemblies or other suitable support structures. The bracket or brackets 14 may be pivotally attached to, or otherwise supported relative to, the backrest section 114, bed deck 116, upper frame 118, base frame 120 or another structural portion of the patient support apparatus 100 through hinges, pivot joints, pins, shafts, axles, bearings, bushings, linkage structures, clevis joints, articulated support members, guide structures or other suitable support arrangements permitting fixed or relative movement between the bracket or brackets 14 and the patient support apparatus 100.

In certain embodiments, the bracket or brackets 14 may support one or more laterally extending structures 16 extending across at least a portion of the width of the mattress M or patient support apparatus 100. The laterally extending structure 16 may support or otherwise be connected relative to the boosting sheet S such that movement of the bracket or brackets 14 causes corresponding movement of the laterally extending structure 16 and the boosting sheet S during operation of the patient positioning device 10’’’’.

Although not shown for purposes of simplicity, a pulley 12 or another suitable guide structure, such as described above with reference to the patient boosting or positioning devices 10, 10’, 10’’ and 10’’’, may additionally be provided in connection with the patient positioning device 10’’’’ to guide or facilitate movement of the boosting sheet S, cable or belt 20 or another flexible member during operation of the patient positioning device 10’’’’. For example, the guide structure may comprise a pulley, roller, rotatable tube, rotatable cylinder, guide rod, guide rail, track, channel, groove, fairlead, eyelet, tubular guide, low-friction slide member, low-friction polymeric guide member, wear strip, bearing-supported guide member or other structure configured to direct or facilitate movement of the sheet S, cable or belt 20. In certain embodiments, the guide structure may comprise or be coated with a low-friction material, including nylon, polytetrafluoroethylene (PTFE), ultra-high-molecular-weight polyethylene (UHMW polyethylene), acetal, polyoxymethylene (POM), polyethylene, polypropylene, fluoropolymer materials, silicone-containing materials or other suitable low-friction materials. It should further be appreciated that, in certain embodiments, a pulley 12 or other guide structure may not be necessary, particularly where the mattress M, sheet S or associated support surfaces provide sufficiently low friction to permit movement of the sheet S relative to the mattress M without substantial resistance.

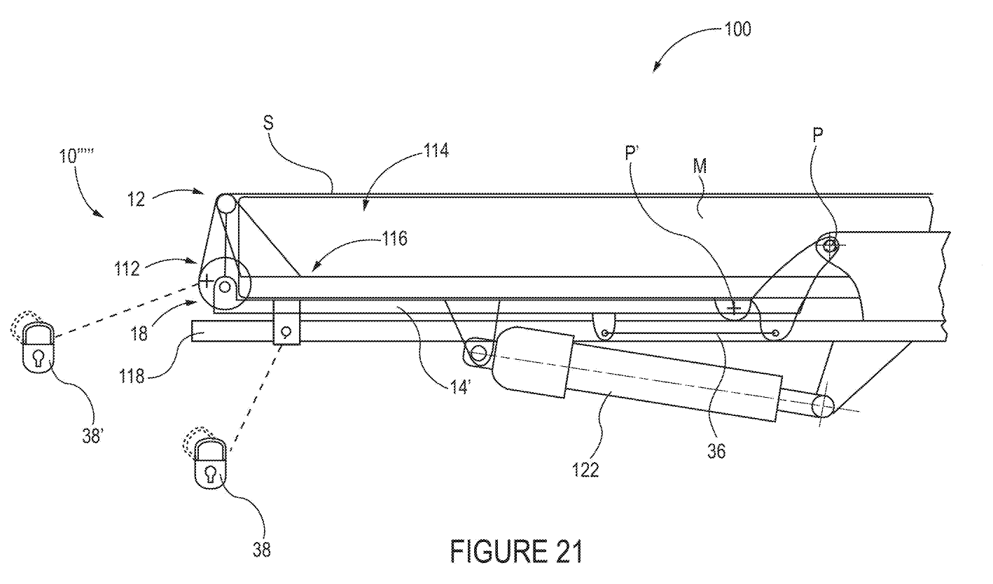

Another patient positioning device 10’’’’’ is illustrated in FIGS. 21-23. The patient positioning device 10’’’’’ builds upon the patient positioning device 10’’’ described above with reference to FIGS. 15-17. As shown in FIGS. 21-23, the bracket or brackets 14 are pivotally attached to the backrest section 114 at pivot point P’ and mechanically biased toward the backrest section 114 by a biasing element 36, such as a spring, counterweight, gas spring or other resilient mechanism. The bracket or brackets 14 may additionally include a damping arrangement configured to control movement of the bracket or brackets 14 relative to the backrest section 114.

In the patient positioning device 10’’’’’, the bracket or brackets 14 further comprise a rotatable cylinder or winder 18 configured to receive and wind a sheet S thereon. The winder 18 may be manually, mechanically or electrically actuated to selectively wind or unwind the sheet S. The bracket or brackets 14 may further be selectively secured relative to the support deck frame 118 through a locking mechanism 38, as shown in FIG. 21. The locking mechanism 38 may comprise a pivotable latch configured to selectively engage a portion of the support deck frame 118 or a servomechanism to prevent movement of the bracket 14 relative thereto. The winder 18 may additionally include a rotational locking mechanism 38’ configured to selectively prevent reverse rotation thereof. In certain embodiments, the winder 18 may further comprise a braking mechanism configured to control rotational movement of the winder 18 during winding or unwinding of the sheet S to improve patient comfort and reduce abrupt movement of the sheet S.

It should be appreciated that the winder 18 may comprise a variety of suitable structures configured to wind, retract, tension, release, secure or otherwise control movement of the boosting sheet S, cable 20 or another flexible member associated with the patient positioning device. For example, the winder 18 may comprise a spool, reel, drum, rotatable cylinder, roller, capstan, hub, shaft-mounted winding member, cable reel, belt reel or another rotatable winding structure. In certain embodiments, the winder 18 may comprise a manually operated winding arrangement, spring-biased winding arrangement, motor-driven winding arrangement, friction-based tensioning arrangement or other suitable winding or tensioning mechanism.

In certain embodiments, the winder 18 may comprise a retractable spring mechanism, constant-force spring mechanism or seatbelt-type retractor configured to automatically remove slack from the cable 20 or sheet S during operation of the patient positioning device. In other embodiments, the winder 18 may comprise a motorized reel driven by an electric motor, stepper motor, servo motor, gearmotor or other actuator configured to selectively wind or unwind the cable 20 or sheet S. Further, the winder 18 may comprise a ratcheting reel, locking spool, friction brake reel, clutch-controlled reel, selectively engageable drum or another mechanism configured to selectively permit or prevent movement of the cable 20 or sheet S.

The winder 18 may additionally comprise one or more guide structures, including pulleys, rollers, fairleads, guide rails, low-friction guides, wear strips, eyelets or other structures configured to direct movement of the cable 20, sheet S or another flexible member during operation of the patient positioning device 10’’’’’.

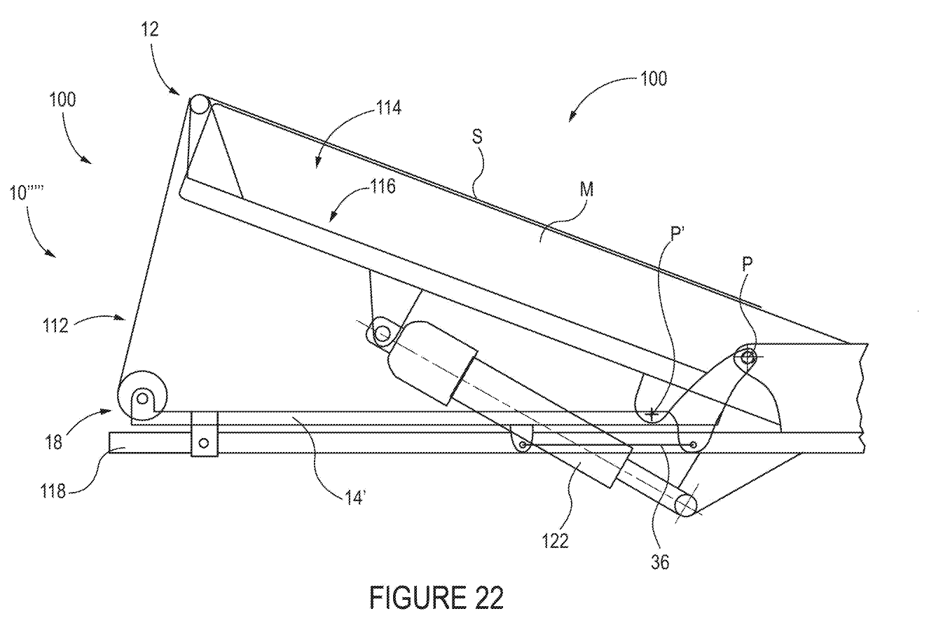

During a patient boosting or positioning operation, and as illustrated in FIGS. 21-22, an operator may activate the patient positioning device 10’’’’’ through a controller or control unit positioned on the patient support apparatus 100, such as the controller or control unit 44 shown in FIGS. 18-20 (e.g., via a button “BOOST ON”). Upon activation, the backrest section 114 may move downward toward a substantially horizontal position relative to the support deck frame 118. Once the backrest section 114 reaches the desired position, the bracket or brackets 14 may be selectively locked relative to the support deck frame 118 through the locking mechanism 38. Substantially simultaneously, the winder 18 may be locked against reverse rotation by the rotational locking mechanism 38’. In certain embodiments, activation of the locking mechanism 38 and the rotational locking mechanism 38’ of the winder 18 may be indicated through one or more visual indicators, such as LED indicators, provided on the controller or control unit.

In certain embodiments, initiation of a patient repositioning operation may be conditioned upon verification of one or more operational states of the patient support apparatus, including position of the backrest section 114, lock status, patient-support surface configuration or other sensed operating conditions.

Following locking of the bracket or brackets 14 relative to the support deck frame 118, and as illustrated in FIG. 22, the backrest section 114 may subsequently move upwardly relative to the support deck frame 118. With the bracket or brackets 14 locked relative to the support deck frame 118, upward movement of the backrest section 114 causes displacement of the sheet S relative to the patient support apparatus 100, thereby repositioning a patient supported on the sheet S toward the head end 112 of the patient support apparatus 100. In certain embodiments, movement of the sheet S may be guided over the guide element 12 positioned adjacent an upper portion of the backrest section 114. Simultaneously with movement of the backrest section 114, the support deck frame 118 may be tilted into a Trendelenburg position to assist repositioning of the patient by reducing the force required for movement of the patient and increasing patient comfort during the positioning operation.

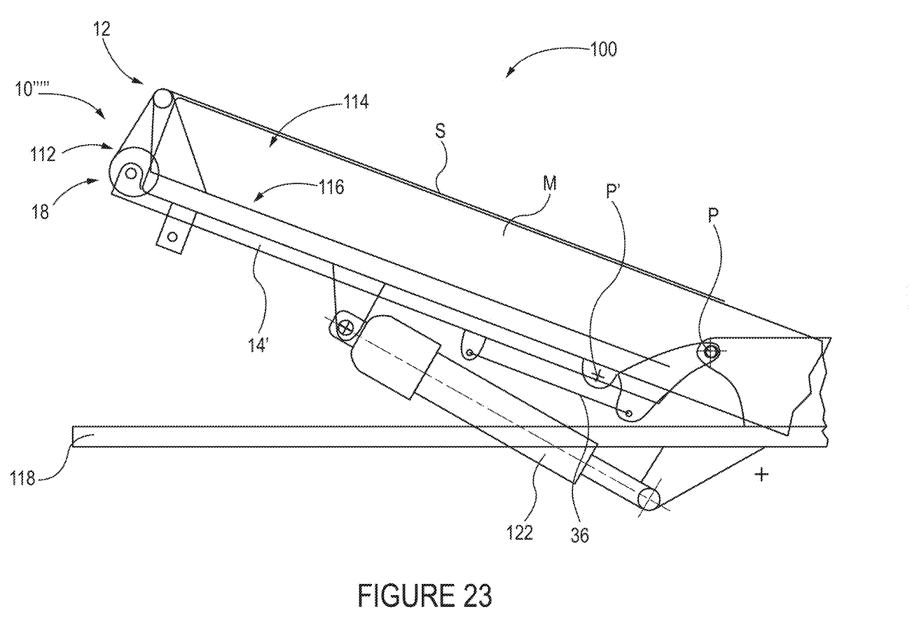

If a desired patient position is not achieved during a single positioning operation, the patient positioning operation may be repeated without disengaging the locking mechanism 38 securing the bracket 14 relative to the support deck frame 118. During subsequent positioning operations, slack portions of the sheet S may be automatically or selectively wound onto the winder 18, as generally illustrated in FIG. 23, to maintain tension within the sheet S and prepare the patient positioning device 10’’’’’ for additional positioning operations.

Following completion of a patient positioning operation, an operator may deactivate the patient positioning device 10’’’’’ through the controller or control unit (e.g., via a button “BOOST OFF”). In response, the backrest section 114 may move downwardly by a sufficient distance to reduce tension within the sheet S. Reduction of tension within the sheet S permits selective unlocking of the winder 18 and disengagement of the locking mechanism 38 securing the bracket 14 relative to the support deck frame 118. Following disengagement of the locking mechanism 38, the bracket 14 may be returned toward the backrest section 114 through the biasing element 36 or through movement of the backrest section 114 toward a substantially horizontal position in which the bracket 14 mechanically engages the backrest section 114, as generally illustrated in FIG. 23.

The sheet S may remain tensioned on the winder 18 through a winding force generated by the winder 18 and supplemental retention forces generated by associated guide members or pulley arrangements. The tensioning force applied to the sheet S may be selected to reduce undesired movement of the patient relative to the sheet S while simultaneously reducing shear forces applied to the patient. In certain embodiments, the operator may selectively position the winder 18 in either a locked condition preventing unwinding of the sheet S or an unlocked condition permitting unwinding of the sheet S. The selected condition of the winder 18 may be indicated through one or more visual indicators associated with the controller or control unit. Concurrently with downward movement of the backrest section 114, the support deck frame 118 may return from the Trendelenburg position toward a substantially horizontal orientation.

As generally illustrated in FIG. 23, the sheet S may be removed from the patient positioning device 10’’’’’ by disengaging the rotational lock of the winder 18 and unwinding the sheet S from the winder 18 by manually pulling the sheet S away from the winder 18.

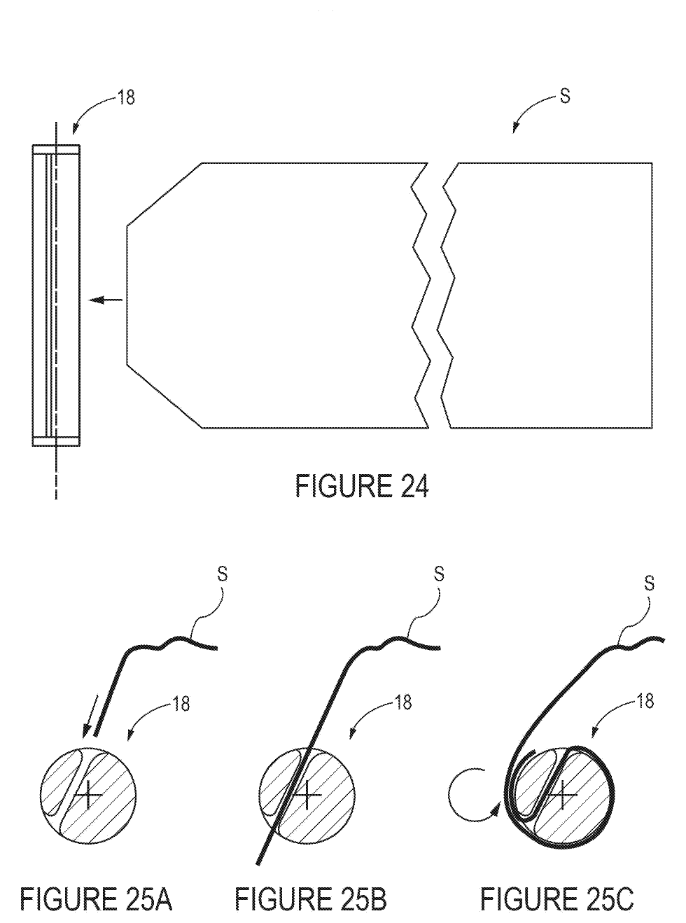

FIG. 24 illustrates an exemplary manner in which a boosting sheet S may be fed into a winder 18. FIGS. 25A-25C illustrate an exemplary winder 18 comprising a longitudinal slot, channel or groove configured to receive an end portion of the sheet S. Upon insertion of the sheet S into the slot, as generally illustrated transitioning between FIGS. 25A-25B, rotation of the winder 18, as generally illustrated in FIG. 25C, causes the sheet S to wrap around the winder 18 and overlap onto itself. When tension is subsequently applied to the sheet S, compressive and frictional forces generated between overlapping portions of the sheet S help retain the sheet S relative to the winder 18 and reduce the likelihood of the sheet S disengaging from the winder 18 during operation.

In certain embodiments, the sheet S may be partially wound onto the winder 18 prior to placement of a patient thereon to secure the sheet S relative to the winder 18 and establish a desired initial tension condition. Prior to patient placement, the sheet S may be smoothed, tensioned or otherwise adjusted to reduce wrinkles, folds or localized pressure concentrations across the support surface.

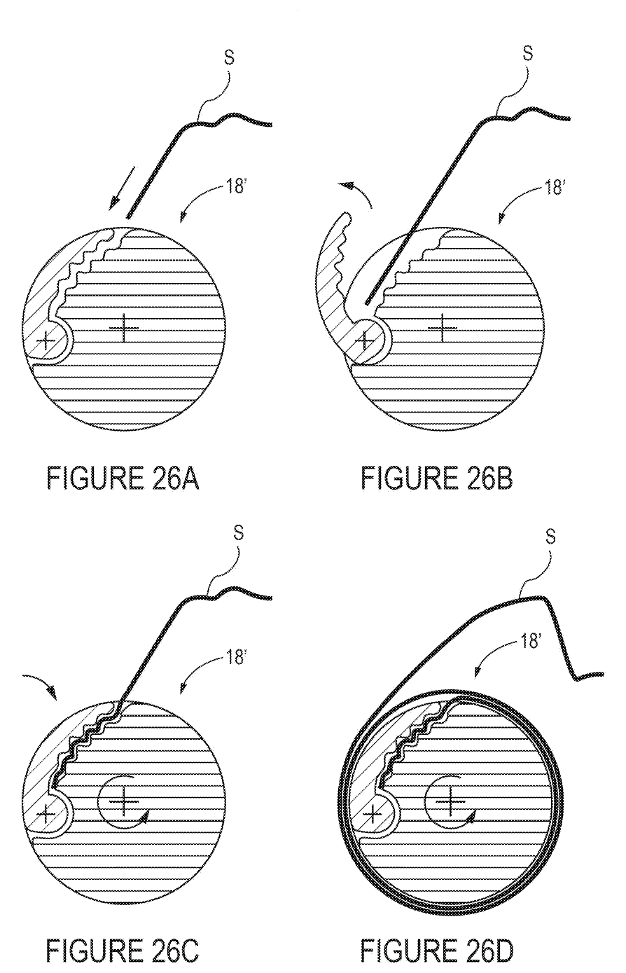

An alternative winder 18’ is illustrated in FIGS. 26A–26D. The winder 18’ comprises a jaw movable relative to a body portion of the winder 18’. In one embodiment, the jaw may be pivoted between an open position, shown in FIG. 26B, and a closed position, shown in FIG. 26A. An end portion of the boosting sheet S may be inserted into a space defined between the jaw and the body portion of the winder 18’ while the jaw is in the open position. Following insertion of the sheet S, the jaw may be moved toward the closed position, shown in FIG. 26C, to clamp or retain the sheet S relative to the winder 18’. Thereafter, rotation of the winder 18’, as illustrated in FIG. 26D, causes the sheet S to wrap around the winder 18’ and overlap onto itself, thereby further retaining the jaw in the closed position. As tension is subsequently applied to the sheet S, compressive and frictional forces generated between the jaw, the winder 18’ and overlapping portions of the sheet S help retain the sheet S on the winder 18’ and reduce the likelihood of disengagement during operation.

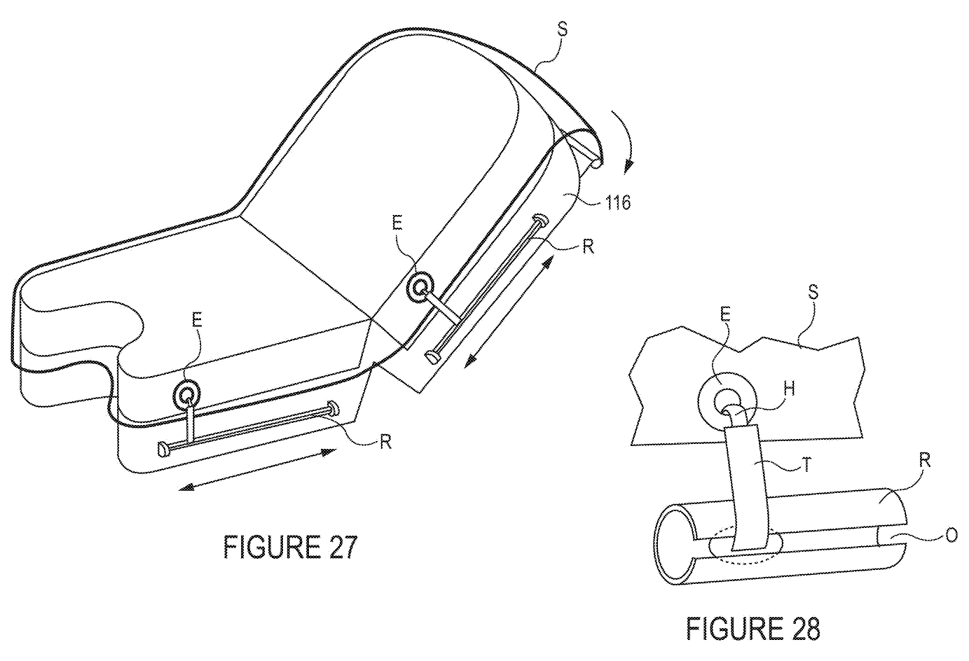

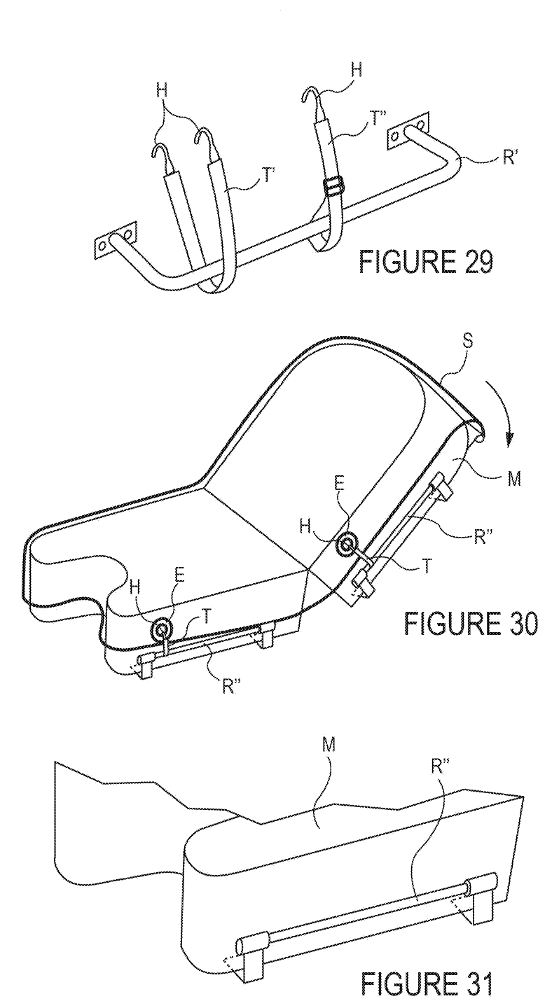

The boosting sheet S may be supported for movement relative to the patient support apparatus 100 in a variety of suitable manners. As shown in FIGS. 27–29, the sheet S may comprise apertures, openings or eyelets E configured to receive hooks H associated with one or more tensioning elements. Each tensioning element may comprise a hook H configured to engage an eyelet E of the sheet S, a flexible or elastic strap T configured to provide a restorative tensioning force, and a terminal element configured for sliding engagement with a guide rail or profile R. In one embodiment, the guide rail or profile R may be supported along lateral sides of the patient support apparatus 100, including portions of the support deck 116. The guide rail or profile R may comprise a channel, track, slot, groove or other guide structure configured to guide longitudinal movement of the tensioning element relative thereto. In one arrangement, the tensioning element may comprise hooks H at opposing ends of a flexible or elastic strap T’, as shown in FIG. 29. In another arrangement, the tensioning element may comprise a hook H at one end and a flexible or elastic strap T’’ slidably supported relative to the guide rail or profile R’ at an opposing end. The flexible or elastic strap T’’ may comprise an adjustment feature (shown but not reference)

The flexible or elastic strap T, T’, T’’ may provide a substantially continuous restorative tensioning force to maintain the sheet S in a substantially taut condition across the support surface. Through engagement with the guide rail or profile R, the tensioning element may be configured for longitudinal sliding movement toward the backrest section 114 when the sheet S is subjected to upward traction during patient positioning operations. In certain embodiments, corresponding tensioning elements may be disposed along opposing lateral sides of the patient support apparatus 100 to provide substantially symmetrical tension distribution across the sheet S.

In alternative embodiments, and as shown in FIGS. 30–31, the guide structure may be integrated into a mattress M or a mattress cover associated with the mattress M or a mattress cover rather than being supported directly relative to the patient support apparatus 100. In such embodiments, the sheet S may similarly comprise apertures, openings or eyelets E configured to receive hooks H associated with one or more tensioning elements. Each tensioning element may comprise a hook H configured to engage the sheet S, a flexible or elastic strap T configured to provide a restorative tensioning force, and a terminal element configured for sliding engagement with a guide rail or profile R’’ integrated into the mattress M or mattress cover. The guide rail or profile R’’ may comprise a channel, track, slot, groove or other guide structure configured to guide longitudinal movement of the tensioning element relative thereto.

The flexible or elastic strap T may provide a substantially continuous restorative tensioning force to maintain the sheet S in a substantially taut condition across the support surface. Through engagement with the guide rail or profile R’’ integrated into the mattress M or mattress cover, the tensioning element may be configured for longitudinal sliding movement toward the backrest section 114 when the sheet S is subjected to upward traction during patient positioning operations. In certain embodiments, corresponding tensioning elements may be disposed along opposing lateral sides of the mattress M or mattress cover to provide substantially symmetrical tension distribution across the sheet S.

Although FIGS. 27–31 illustrate the guide rail or profile R and associated tensioning elements in connection with a birthing bed or similar patient support apparatus 100, it should be appreciated that the disclosed sheet-tensioning arrangements may likewise be employed with other patient support apparatus configurations, including hospital beds, stretchers, procedure tables, rehabilitation beds and other patient support systems. Different patient support apparatus configurations may include different structural arrangements, mattress geometries, articulation systems, support deck configurations or space constraints, and corresponding embodiments of the patient positioning device may be adapted accordingly.

In alternative embodiments, the guide structure may be integrated into a mattress cover associated with the mattress M rather than supported directly on the patient support apparatus 100. In such embodiments, the tensioning element may similarly comprise a hook configured to engage an aperture, opening or eyelet of the sheet S, a flexible or elastic strap, and a terminal element configured for engagement with the guide structure integrated into the mattress cover. The guide structure may permit longitudinal displacement of the tensioning element relative to the mattress cover during repositioning operations while maintaining tension within the sheet S. Symmetrical arrangements may likewise be provided along opposing lateral sides of the mattress cover to maintain substantially uniform tension across the sheet S.

It should be appreciated that different embodiments described herein may be adapted for use with different patient support apparatus configurations, including conventional hospital beds, birthing beds and other specialized patient support systems. Differences in bed architecture, support deck geometry, mattress dimensions and mattress thickness may result in corresponding differences in the configuration of the patient positioning device, sheet support structures, sheet retention arrangements and drive mechanisms employed with particular embodiments.

It should further be appreciated that certain embodiments may employ independent drive mechanisms for actuating movement of the sheet, while other embodiments may utilize movement of existing bed articulation systems, including movement of a backrest section, upper frame or lifting mechanism of the patient support apparatus. Likewise, sheet fixation and retention arrangements may vary between embodiments depending upon the structural configuration of the patient support apparatus 100 and the desired operational characteristics of the patient positioning device.

In certain embodiments, the sheet S may be received within a groove or channel formed in a rotatable cylinder or winding member supported relative to a bracket of the patient positioning device. The rotatable cylinder or winding member may be configured to receive, retain and selectively wind portions of the sheet S during operation of the patient positioning device. The rotatable cylinder or winding member may additionally cooperate with one or more locking, braking or tensioning mechanisms to control movement of the sheet S during patient repositioning operations.

It should further be appreciated that the patient positioning devices described herein may form part of an integrated patient support system in which patient repositioning operations are coordinated with additional functions of the patient support apparatus. In certain embodiments, operation of the patient positioning device may be synchronized with movement of one or more articulated sections of the patient support apparatus, movement of an upper frame relative to a base frame, activation of therapeutic positioning functions, movement into or out of a Trendelenburg position, operation of pressure redistribution systems, or activation of ergonomic support features configured to reduce subsequent migration of the patient following repositioning.

In certain embodiments, operation of the patient positioning device may be coordinated through existing control systems, processors, sensors or software architectures of the patient support apparatus rather than through a standalone control system dedicated solely to patient repositioning.

In certain embodiments, operation of the patient positioning device may be followed by automatic or semi-automatic adjustment of one or more support surfaces or articulated sections of the patient support apparatus 100 to maintain patient positioning and reduce downward migration of the patient relative to the mattress. Such coordinated operation may improve patient comfort, reduce caregiver intervention and reduce shear or friction forces acting on the patient following repositioning operations.

In certain embodiments, operation of the patient positioning device may be automatically coordinated with one or more positioning or articulation functions configured to reduce subsequent downward migration of the patient following repositioning.

In one embodiment, the sheet S includes a sleeve or tunnel attachment configured to slide over the bracket or brackets 14. The sleeve or tunnel attachment of the sheet S may extend generally laterally across the sheet S proximate an upper or head-end portion thereof. The laterally extending structure 16, rod, tube, cross-member or another support member associated with the bracket or brackets 14 may extend through the sleeve or tunnel attachment such that movement of the bracket or brackets 14 causes corresponding movement of the sheet S relative to the mattress M and patient support apparatus 100. In another embodiment, the sheet S is secured through an eyelet-and-hook attachment. In a further embodiment, the sheet S includes a profile strip attachment, such as a flexible bead, welt, spline, rib, enlarged edge portion or other retention profile secured relative to the sheet S, configured to slide into a C-channel, groove or other receiving structure formed on the bracket 14.

It should also be appreciated that the sheet S may comprise one or more caregiver interaction structures configured to facilitate handling, positioning or adjustment of the sheet S relative to the patient support apparatus. Such interaction structures may include tabs, handles, loops, reinforced regions, grasping portions or other suitable structures configured to assist caregivers in manually repositioning, centering, tensioning or otherwise manipulating the sheet S before, during or after operation of the patient positioning device.

In certain embodiments, the sheet S may be positioned loosely relative to the mattress M and need not be tucked beneath the mattress M or laterally fixed relative to opposing lateral sides of the patient support apparatus 100. The sheet S may instead rest atop the mattress M and be movable relative thereto during patient repositioning operations.

In certain embodiments, the sheet S may be positioned directly adjacent the mattress M or another support surface without intervening bedding layers that substantially impair movement of the sheet S relative to the mattress M during patient repositioning operations. In other embodiments, one or more intermediate layers may be provided so long as desired repositioning performance is maintained.

One or more patient-support layers, including absorbent pads, incontinence pads, draw sheets or protective layers, may be positioned between the patient and the sheet S provided such layers do not substantially interfere with repositioning performance of the patient positioning device.

The sheet S may comprise dimensions selected to facilitate patient repositioning while reducing bunching, folding, wrinkling or localized pressure concentrations during operation of the patient positioning device.

In certain embodiments, the sheet S may comprise materials and constructions compatible with institutional laundering, sanitization and healthcare cleaning procedures associated with hospitals, nursing facilities and other clinical environments.

As stated above, it should be appreciated that the patient positioning devices described herein are not limited to use with hospital beds and may be employed with a wide variety of patient support apparatus 100 and healthcare support surfaces. Exemplary applications may include birthing beds, stretchers, transport gurneys, emergency room beds, surgical tables, procedure tables, examination tables, imaging tables, intensive care beds, bariatric beds, rehabilitation beds, long-term care beds, nursing-home beds, home-care beds, pediatric beds, dialysis chairs or recliners, infusion chairs, treatment chairs, wheelchairs, recliners and other therapeutic or patient-support platforms configured to support a patient during treatment, transport, recovery or caregiving procedures. The patient positioning devices described herein may additionally be adapted for veterinary, rehabilitation or non-medical support applications in which repositioning or movement of a supported person or subject may be desirable.

The patient positioning devices described herein may therefore be integrated with existing patient support apparatus functions and control systems to provide coordinated patient repositioning operations rather than isolated or standalone patient movement functions.

The patient positioning device may improve patient comfort because the patient need not be raised during repositioning and may reduce caregiver lifting requirements, which may be advantageous for heavier or less mobile patients.

Further, it should be understood that the invention is not intended to be limited to use of a winder and that any suitable structure may be employed that enables the cable or sheet to be selectively free or selectively secured.

It should be noted that orientational terms used throughout this description are with reference to the orientation of the invention and component parts thereof as presented in the accompanying drawings, which orientation is subject to change. Therefore, orientational terms are used for semantic purposes and do not limit the invention or its component parts to any particular orientation.

While the invention and component parts thereof may have been described herein in terms of certain components being referred to in either the singular or the plural, other arrangements are possible. For example, components presented in the singular may be provided in the plural, and components presented in the plural may be provided in the singular. Although the invention may be described as comprising one or more components, additional components may be provided and arranged accordingly.

A method of repositioning a patient relative to a patient support apparatus 100 may comprise the step of positioning a sheet S beneath or relative to a patient supported on a mattress M of the patient support apparatus 100. The sheet S may be operatively connected relative to one or more brackets 14, laterally extending structures 16, winders 18, cables 20, drive mechanisms 22 or other repositioning structures associated with the patient positioning device. The method may further comprise the step of selectively actuating, locking, tensioning, releasing or otherwise operating one or more components of the patient positioning device to move the sheet S relative to the mattress M and thereby reposition the patient toward a head end 112 of the patient support apparatus 100.

In certain embodiments, the step of repositioning of the patient may be accomplished through movement of one or more articulated portions of the patient support apparatus 100, including movement of a backrest section 114, upper frame 118 or lifting mechanism relative to another portion of the patient support apparatus 100. In other embodiments, the step of repositioning of the patient may be accomplished through operation of an independent drive mechanism 22 configured to move, pivot, rotate, tension or otherwise actuate one or more repositioning structures associated with the sheet S.

The method may further comprise the step of selectively locking or releasing movement of a cable 20, sheet S, bracket 14, winder 18 or another movable component associated with the patient positioning device before, during or after a patient repositioning operation. In certain embodiments, the method may comprise the step of tensioning, winding or retracting a cable 20 or sheet S to remove slack and maintain the sheet S in a desired condition relative to the patient support apparatus 100. The method may additionally comprise the step of returning one or more components of the patient positioning device toward an initial, home or baseline position following completion of a repositioning operation.

In one method of operation, the patient support apparatus 100 may initially be positioned in a boosting-ready configuration in which the patient support apparatus 100 is substantially free of lateral or longitudinal tilt and one or more braking mechanisms are engaged. A patient positioned on the sheet S may have migrated downwardly toward the foot end of the patient support apparatus 100, while the backrest section 114 remains positioned within a predetermined angular range relative to horizontal. Following verification of patient status and one or more operational conditions of the patient support apparatus 100, an operator may activate the patient positioning device through a controller or control unit, such as by pressing and holding a designated control input. In response, the backrest section 114, with the sheet S secured relative to the winder 18, may move toward a substantially horizontal or baseline position. Upon reaching the baseline position, the bracket 14 and/or winder 18 may automatically be secured relative to the support deck frame 118, and a rotational locking mechanism may engage to prevent reverse rotation of the winder 18. Activation of the locking mechanisms may be indicated through one or more visual indicators associated with the controller or control unit. Thereafter, upward movement of the backrest section 114 tensions and displaces the sheet S, which may be guided over a roller, tube or guide element 12 positioned adjacent the backrest section 114, thereby repositioning the patient toward the head end 112 of the patient support apparatus 100. Simultaneously with movement of the backrest section 114, the patient support apparatus 100 may be moved into a Trendelenburg position to assist repositioning of the patient and reduce gravitational resistance to patient movement. If a desired patient position is not achieved during a single repositioning cycle, the repositioning procedure may be repeated, including reduction of tension within the sheet S and subsequent re-engagement of the locking mechanisms.

Following completion of a patient repositioning operation in which the patient has reached a desired position relative to the patient support apparatus 100, the patient support apparatus 100 may remain temporarily positioned in a post-boost configuration in which the backrest section 114 remains elevated, the patient support apparatus 100 optionally remains in a Trendelenburg orientation, and the sheet S remains tensioned between the patient and the winder 18 while the bracket 14 and/or winder 18 remains secured relative to the support deck frame 118. An operator may thereafter deactivate the patient positioning device through a designated control input associated with the controller or control unit. In response, the backrest section 114 may automatically move downwardly by a predetermined distance sufficient to reduce tension within the sheet S. Following reduction of sheet tension, the bracket 14 and/or winder 18 may be disengaged or unlocked relative to the support deck frame 118 and returned toward a normal operating condition relative to the backrest section 114, including through operation of a gas spring, resilient member or movement of the backrest section 114 toward a baseline position. A rotational locking mechanism associated with the winder 18 may additionally be released so that the sheet S remains retained relative to the winder 18 through a controlled winding force and auxiliary retention forces generated by associated pulleys, guides or frictional interfaces. The winding force may be selected to maintain patient positioning while reducing shear forces acting on the patient. Simultaneously with downward movement of the backrest section 114, the patient support apparatus 100 may return from the Trendelenburg orientation toward a substantially horizontal orientation. In certain embodiments, excess portions of the sheet S generated during the repositioning operation may be wound onto the winder 18 to prepare the patient positioning device for subsequent repositioning operations. Following completion of the post-boost procedure, the patient support apparatus 100 may resume normal operating functionality, and one or more migration-reduction functions, including adjustment of a thigh section, articulation of a support surface or positioning in a slight Trendelenburg orientation, may be activated to reduce subsequent downward migration of the patient.

In certain embodiments, resetting or replacement of the sheet S may comprise manual or powered unwinding of the sheet S from the winder 18, disengagement of a sheet-retention mechanism, insertion of a replacement sheet S and rewinding of the replacement sheet S onto the winder 18.

In certain embodiments, operation of the patient positioning device may be initiated, monitored or controlled remotely through wired or wireless communication systems. For example, the controller or control unit may communicate with remote caregiver controls, handheld devices, nurse-station systems, hospital information systems, mobile applications or network-connected patient support management systems. Remote operation may permit initiation of repositioning operations, monitoring of patient position, status reporting, alarm generation or adjustment of operational parameters associated with the patient positioning device.

In certain embodiments, the patient support apparatus 100 may comprise one or more sensors configured to monitor patient position, patient migration, support-surface loading, articulation position or other operational parameters associated with the patient positioning device. Information generated by such sensors may be used to provide caregiver alerts, recommend repositioning operations, automatically initiate positioning sequences or track patient movement over time.

In certain embodiments, operational information associated with the patient positioning device may be stored, transmitted or communicated to external systems. Exemplary information may include repositioning cycle counts, patient-positioning history, operational status, alarm conditions, sensor data, maintenance information or caregiver interaction data. Such information may be communicated through wired or wireless communication interfaces to hospital networks, caregiver monitoring systems, electronic medical record systems or maintenance-management systems.

In certain embodiments, the controller or control unit may additionally provide audible prompts, voice guidance, spoken status notifications or other audio-based caregiver assistance features during operation of the patient positioning device.

In certain embodiments, one or more support sections of the patient support apparatus 100 may automatically articulate following completion of a repositioning operation to reduce subsequent downward migration of the patient and maintain ergonomic patient positioning.

In accordance with the provisions of the patent statutes, the principle and mode of operation of this invention have been explained and illustrated in preferred embodiments. However, it must be understood that this invention may be practiced otherwise than as specifically explained and illustrated without departing from its spirit or scope.

### PARTS LIST

10 patient positioning device
10’ patient positioning device
10’’ patient positioning device
10’’’ patient positioning device
10’’’’ patient positioning device
10’’’’’ patient positioning device
12 pulley or guide structure
14 bracket
14’ bracket
16 laterally extending structure
18 winder
18’ winder
20 cable
22 drive mechanism
24 cable tensioning device
26 guide pulley
28 rack
30 track
32 spring or biasing element
34 locking member
36 biasing element
38 locking element
40 pulley
42 pulley
44 controller or control unit
46 return spring or resilient return element
100 patient support apparatus
112 head end
114 backrest section
116 bed deck
118 upper frame
120 chassis or base frame
122 drive component
124 lifting column or lifting mechanism
126 siderail
128 control unit
S sheet
M mattress
P pivot point
B bubble
P’ pivot point
E eyelet
R guide rail or profile
T tensioning element or flexible strap O opening
H hook
T’ tensioning element or flexible strap
T’’ tensioning element or flexible strap
R’ guide rail or profile
R’’ guide rail or profile

What is claimed is:

1. A patient support apparatus comprising:
a frame;
a backrest section supported for movement relative to the frame;
a sheet configured to support a patient; and
a sheet displacement mechanism configured such that movement of the backrest section relative to the frame causes movement of the sheet to reposition the patient.

2. The patient support apparatus of claim 1, wherein the first part comprises a backrest section and the second part comprises a frame of the patient support apparatus.

3. The patient support apparatus of claim 2, wherein movement of the backrest section relative to the frame comprises pivotal movement about a pivot point.

4. The patient support apparatus of claim 3, further comprising a bracket having:
a first end operatively connected to the backrest section; and
a second end configured to support the sheet relative thereto, wherein the connecting element is operatively connected to the bracket.

5. The patient support apparatus of claim 4, wherein the bracket pivots relative to the backrest section and is biased toward the backrest section by a biasing element.

6. The patient support apparatus of claim 1, wherein the sheet displacement mechanism comprises a connecting element.

7. The patient support apparatus of claim 6, further comprising a tensioning device configured to tension the connecting element.

8. The patient support apparatus of claim 7, wherein the slack-removal device comprises a winder having a locking mechanism configured to selectively prevent movement of the connecting element.

9. The patient support apparatus of claim 6, wherein the connecting element is operatively connected between the first part and at least one of an upper frame or a base frame of the patient support apparatus.

10. The patient support apparatus of claim 1, further comprising a guide element positioned adjacent an upper corner of a mattress for guiding movement of the sheet.

11. The patient support apparatus of claim 10, wherein the guide element comprises a pulley.

12. The patient support apparatus of claim 1, wherein operation of the patient support apparatus to reposition the patient is permitted only when the first part is positioned within a predetermined angular range.

13. The patient support apparatus of claim 12, wherein the predetermined angular range is between approximately 0° and approximately 30° from horizontal.

14. The patient support apparatus of claim 1, further comprising a controller having a safety lockout configured to prevent unintended activation of the patient support apparatus.

15. A patient support apparatus comprising:
a sheet configured to support a patient;
a bracket operatively associated with the sheet; and
a drive mechanism configured to move the bracket relative to a patient support apparatus to reposition a patient supported on the sheet.

16. The patient support apparatus of claim 15, further comprising a bracket supporting the winder and pivotally supported relative to the backrest section.

17. The patient support apparatus of claim 16, wherein the bracket is selectively lockable relative to the upper frame.

18. The patient support apparatus of claim 15, wherein the winder comprises a rotational locking mechanism configured to selectively prevent reverse rotation of the winder.

19. The patient support apparatus of claim 15, wherein the upper frame is movable into a Trendelenburg position during repositioning of the patient.

20. A method of repositioning a patient on a patient support apparatus comprising the steps of:
a) supporting a patient on a sheet positioned relative to a movable portion of the patient support apparatus;
b) selectively securing a sheet displacement mechanism relative to the patient support apparatus; and
c) moving the movable portion of the patient support apparatus such that movement of the sheet displacement mechanism causes movement of the sheet to reposition the patient.
